(19) United States
(12) Patent Application Publication
(10) Pub. No.: US 2019/0347955 A1
(43) Pub. Date: Nov. 14, 2019

(54) SYSTEMS AND METHODS FOR CREATING AND EVALUATING REPEATABLE AND MEASURABLE LEARNING CONTENT

(71) Applicants: Laura Paramoure, Raleigh, NC (US); Richard Michelli, Raleigh, NC (US)

(72) Inventors: Laura Paramoure, Raleigh, NC (US); Richard Michelli, Raleigh, NC (US)

(21) Appl. No.: 16/423,797

(22) Filed: May 28, 2019

Related U.S. Application Data
(63) Continuation-in-part of application No. 14/593,222, filed on Jan. 9, 2015, now abandoned.
(60) Provisional application No. 61/925,767, filed on Jan. 10, 2014.

(51) Int. Cl. G09B 19/00; G09B 7/00

(52) U.S. Cl. CPC G09B 19/00; G09B 7/00

(57) ABSTRACT

Systems and methods for creating and evaluating measurable training content to include creating a measurable learning design are disclosed. A system includes a user interface for identifying the one or more metrics to be influenced by a learning program and for identifying behaviors that affect the one or more identified metrics; a design module having at least one processor and memory for creating measurable objectives for the identified behaviors, creating one or more evaluations for each the measurable objectives; creating a learning strategy for one or more measurable objectives such that the identified behaviors are acquired, and creating an assessment using the created set of evaluations such that the assessment may be delivered to each student attending the learning program and provide a quantification of learning achievement of the student.

### CROSS REFERENCE TO RELATED APPLICATIONS

This is a continuation-in-part patent application that claims priority to U.S. Non-Provisional patent application Ser. No. 14/593,222, filed Jan. 9, 2015 and titled SYSTEMS AND METHODS FOR CREATING AND EVALUATING REPEATABLE AND MEASURABLE LEARNING CONTENT, which claims priority to U.S. Provisional Patent Application No. 61/925,767, filed Jan. 10, 2014 and titled SYSTEM AND METHOD FOR CREATING REPEATABLE AND MEASURABLE LEARNING CONTENT; the contents of which are hereby incorporated herein by reference in their entireties.

### TECHNICAL FIELD

The present disclosure relates to systems and methods for assisting teachers, professors, trainers, human resource professionals, and the like to create and evaluate measurable training content, and quantifying the level of knowledge, skill, or attitude changes gained by training candidates from a training session.

### BACKGROUND

In corporate organizations and the like, there arise situations when improvement is desired in performance of the organization and the performance is quantified in one or more performance metrics, where the metrics are influenced by behaviors of the individuals within the organization. Often training is utilized to attempt to achieve this improvement, but difficulty arises in 1) linking the training content to the specific behaviors that influence the metrics, 2) quantifying the level of behavior changed achieved by the training, and 3) quantifying the long-term retention of the behavior changes, which ultimately influence the performance metrics.

This difficulty leads to training programs being ineffective at creating the desired improvement in the metrics. If training programs are not designed to address the behaviors that influence the metrics then they will not result in the desired improvement. In addition, if the level of behavior change cannot be quantified there is no ability to objectively measure training's effectiveness. Finally, if the long-term retention of behavior changes is not known, it is impossible to distinguish between the system's training ability to create behavior change and the factors that impede the use of those behaviors beyond the training program. With the inability of the system being able to fully distinguish between and determine the metrics based on behaviors which influence them, the system may execute redundant and undesired processing at the design level. This may lead to excessive hardware failure over time while producing inaccurate results to the user of the learning program.

In view of the foregoing, there arises a need for improved techniques for designing training programs that link training content to specific behaviors in such a way that the level of behavior change can be quantified, and the results can be correlated to metric changes.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with embodiments, systems and methods are provided for creating, by a design module, a measurable learning design intended to influence one or more metrics by identifying the specific behaviors that affect the metrics and developing them into measurable learning objects such that performance against the metrics can be measured at both individual and group behavior levels. The measurable learning design may further include identifying, by a metric identification module of the design module, the metrics intended to be influenced by the learning program; creating, by an objectives design module of the design module, individual measurable objectives for the identified specific behaviors; creating, by an evaluations design module of the design module, one or more evaluations for each of the measurable objectives; creating, by an instructional strategy module of the design module, a learning strategy for one or more measurable objectives such that the identified behaviors are acquired; and creating, by an assessment design module of the design module, an assessment using the created set of evaluations such that the assessment can be delivered to a plurality of training candidates attending the learning program and provide a quantification of their learning achievement. The method may further include calculating, by a computation module, learning performance against the specific behaviors at a training candidate level and a class level, to calculate performance changes between points along the learning timeline, and to correlate the results to observed changes in the one or more metrics intended to be affected by the learning design. The method may further include identifying, by a planning module, one or more of the training candidates to receive the training to schedule the learning timeline (i.e. pre, post, and transfer dates), and to capture both metric and student performance data at multiple points along the learning timeline. The method may further include delivering, by a communications module, learning assessments to identified one or more training candidates to capture their performance on said learning assessment.

In accordance with embodiments, methods are provided for creating, by a design module, a measurable learning design intended to influence one or more metrics by creating a measurable learning design for influencing one or more organizational metrics by identifying behaviors that affect the one or more organizational metrics and for developing measurable learning units to teach such behaviors such that performance against the learning units is measurable and can be correlated with performance for one or more metrics at both individual and group behavior levels. The measurable learning units are defined by one of any one of a learning strategy, an evaluation, and an objective in which the performance against the measurable learning unit is calculated by determining the performance against the objective, constructing measurable objectives to include a verb reflecting the comprehension level to which the learning should occur, a condition that describes the state under which the behavior must be achieved, and criteria for determining if the objective was successfully met, wherein the measurable objective comprises multiple discrete components including verb, condition, and criteria, stored in the memory. The discrete components are reused by other measurable objectives, and creating one or more evaluations for each of the measurable objectives. The type of the one or more evaluations is automatically identified based on the objective's domain and verb. The method also includes creating a learning strategy for the one or more measurable objectives. The learning strategy is stored in memory such that the identified behaviors are acquired. The learning strategy is recommended based on the objective's domain, which is readily identified from the objective's verb discrete component, creating an assessment using the created set of evaluations such that the assessment is delivered to each student attending the learning program and provide a quantification of learning achievement of the student. The learning achievement is aggregated to show specific performance by any one of evaluations, objectives, learning units, and metrics, and calculating, by the specialized processor, learning performance against the behaviors at one of an individual user level and a group user level and a group user level. Further, the method executes the steps of calculating performance changes between points along a learning timeline, correlating the results to observed changes in the one or more metrics intended to be affected by the learning design, identifying a plurality of design objectives within the learning design, and extracting the identified design objectives. The method further includes linking the constructed measurable objectives with the extracted design objectives to form a plurality of predicted objective components, determining a prediction weight for each of the plurality of predicted objective components, determining whether the prediction weight exceeds a predetermined threshold, and in response to determining whether the prediction weight exceeds a predetermined threshold, extracting the constructed measurable objectives enhances the functionality and speed of the specialized processor when correlating the results to observed changes in the one or more metrics intended to be affected by learning design.

In accordance with of the present disclosure, systems and methods are provided for creating and evaluating repeatable and measurable learning content. According to an aspect, a system may include a user interface. A mastery test of a learning program may be presented on the user interface during a training session. The system may also include a design module including at least one processor and memory. The design module may be configured to create the mastery test from a set of evaluations for a learning goal of the learning program. The system may further include a training module including one or more processors and memory. The training module may be configured to determine a performance metric associated with the learning goal after completion of the mastery test during the training session. The system may also include an assessment module including at least one processor and memory. The assessment module may be configured to determine a learning assessment metric based on the performance metric after the completion of the training session. The system may further include a communications module that may further one or more processors and memory. The communications module may be configured to communicate the learning assessment metric to a computing device via the user interface after the completion of the training session.

In accordance with the embodiments of the present disclosure, systems and methods are provided for creating and evaluating repeatable and measurable learning content. According to an aspect, a system may include a user interface configured to present a mastery test of a learning program or to receive mastery test results from another system and at least one specialized processor and memory that includes a design module configured to identify one or more metrics to be influenced by the learning program, identify specific behavior that affects the identified metrics, and construct one or more measurable objectives that include a verb reflecting the comprehension level to which the learning occurs, a condition that describes the state under which the behavior is to be achieved, and criteria for determining whether the objective was successfully met. The design module may also be configured to create evaluations for each of the measurable objectives, wherein a type of the one or more evaluations is automatically identified based on the objective's domain and verb, create a mastery test from the set of evaluations. The system may also include an assessment module which may be configured to determine the level of learning achieved after the completion of the training session and a level retained for a predetermined period of time after training completion, wherein the learning achievement is aggregated to show specific performance by evaluations, objectives, learning units, and metrics. The system further include a measurement module that may be configured to determine a performance metric associated with a learning goal before and after the training event, calculate performance changes between points along a learning timeline, correlate results to observed changes in the one or more metrics intended to be affected by the learning design, and communicate at least one of the learning achievement levels and the performance metric via the user interface after completion of the training session. The design module may be further configured to identify a plurality of design objectives within the learning design, extract the identified design objectives, link the constructed measurable objectives with the extracted design objectives to form a plurality of predicted objective components, determine a prediction weight for each of the predicted objective components, and determine whether the prediction weight exceeds a predetermined threshold. In response to the design module determining that the prediction weight exceeds a predetermined threshold, the design module may extract the constructed measurable objectives from the learning design, whereby extracting the constructed measurable objectives enhances the functionality and speed of the specialized processor when correlating the results to observed changes in the one or more metrics intended to be affected by learning design.

In accordance with embodiments of the present disclosure, a system may include a design module having one or more processors and memory. The design module may be configured to create a measurable learning design intended to influence a specific metric (or metrics) by identifying the specific behaviors that affect the metric(s) and developing them into measurable learning objects such that performance against the metric(s) can be measured at the individual behavior level. The design module may further include a metric identification module to identify the metric (or metrics) intended to be influenced by the learning program. The design module may further include an objectives design module to create individual measurable objectives for the identified specific behaviors. The design module may also include an evaluations design module for creating one or more evaluations for each of the measurable objectives. The design module may also include an instructional strategy module. The design module may be configured to create a learning strategy for one or more measurable objectives such that the identified behaviors are acquired. The design module may further include an assessment design module for creating an assessment instrument, such as a mastery test, using the created set of evaluations. The assessment instrument can be delivered to students attending the learning program and may provide a quantification of the learning achievement of the students. The system may also include a planning module including one or more processors and memory configured to identify the specific students to receive the training, to schedule the learning timeline (i.e., pre, post, and transfer dates), and to capture both metric and student performance data at multiple points along the learning timeline. The system may also include a communication module having one or more processors and memory configured to deliver learning assessments to identified students and capture their performance on said learning assessment. The system may furthermore include a computation module comprising one or more processors and memory configured to calculate learning performance against the specific behaviors at both the individual (student) and group (class) levels, to calculate performance changes between points along the learning timeline, and to correlate the results to observed changes in the metric (or metrics) intended to be affected by the learning design.

In accordance with embodiments of the present disclosure, a method is provided for evaluating one or more training candidates in a training session. The method may include presenting, on a user interface, a mastery test of a learning program during the training session. The method may also include creating, by a design module, the mastery test from a set of evaluations for a learning goal of the learning program. The method may also include determining, by a training module, a performance metric associated with the learning goal after completion of the mastery test during the training session. The method may further include determining, by an assessment module, a learning assessment metric based on the performance metric after the completion of the training session. The method may further include communicating, by a communications module, the learning assessment metric to a computing device via the user interface after the completion of the training session.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIGS. 1A-1D illustrate schematic diagrams of example environments within which various embodiments of the present disclosure may function;

FIG. 2 illustrates a block diagram of example system elements of a content management system in accordance with embodiments of the present disclosure;

FIG. 3 illustrates a block diagram of example system elements of a content management system in accordance with embodiments of the present disclosure;

FIG. 4 illustrates a block diagram of example system elements of a content management system in accordance with embodiments of the present disclosure;

FIG. 5 illustrates a flowchart of an exemplary method for determining a learning assessment metric in accordance with embodiments of the present disclosure;

FIGS. 6A and 6B illustrate a flowchart of an exemplary method for calculating a learning performance of one or more training candidates in accordance with embodiments of the present disclosure;

FIGS. 7A and 7B illustrate a flowchart of an exemplary method for assessing performance of a training candidate in accordance with embodiments of the present disclosure;

FIGS. 8A and 8B illustrate a flowchart of an exemplary method for assessing performance of a training candidate in accordance with embodiments of the present disclosure;

FIGS. 9A-9C illustrate a flowchart of an exemplary method for creating measurable objectives in accordance with embodiments of the present disclosure;

FIG. 10 illustrates a flowchart of an exemplary method for creating an instruction plan (or a course design document) in accordance with embodiments of the present disclosure;

FIG. 11 illustrates a flowchart of an exemplary method for creating an evaluation test or mastery test in accordance with embodiments of the present disclosure;

FIGS. 12A and 12B illustrate a flowchart of an exemplary method for evaluating performance of a training candidate and providing a result summary in accordance with an embodiment of the present disclosure;

FIG. 13 illustrates data structure used to implement various embodiments of the present disclosure;

FIG. 14 illustrates an example user interface for creating measurable objectives in accordance with an embodiment of the present disclosure;

FIG. 15 illustrates a flowchart of an exemplary method for constructing measurable objectives from the learning design in accordance with embodiments of the present disclosure; and

FIG. 16 illustrates a flowchart of an exemplary method for extracting constructed measurable objectives from the learning design in according with embodiments of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

The functional units described in this specification have been labeled as modules or devices. A module or device may be implemented in programmable hardware devices such as one or more processors, digital signal processors, central processing units (CPUs), field programmable gate arrays, programmable array logic, programmable logic devices, cloud processing systems, or the like. The modules or devices may also be implemented in software for execution by various types of processors. An identified module or device may include executable code and may, for instance, comprise one or more physical or logical blocks of computer instructions, which may, for instance, be organized as an object, procedure, function, or other construct. Nevertheless, the executables of an identified device need not be physically located together, but may comprise disparate instructions stored in different locations which, when joined logically together, comprise the device and achieve the stated purpose of the device.

Indeed, an executable code of a module or device may be a single instruction, or many instructions, and may even be distributed over several different code segments, among different applications, and across several memory devices. Similarly, operational data may be identified and illustrated herein within the module or device, and may be embodied in any suitable form and organized within any suitable type of data structure. The operational data may be collected as a single data set, or may be distributed over different locations including over different storage modules or devices, and may exist, at least partially, as electronic signals on a system or network.

As referred to herein, the term “computing device” should be broadly construed. It can include any type of mobile device, for example, a smart phone, a cell phone, a pager, a personal digital assistant (PDA, e.g., with GPRS NIC), a mobile computer with a smart phone client, or the like. A computing device can also include any type of conventional computer, for example, a desktop computer, a laptop computer, a netbook computer, a notebook computer, or the like. A typical mobile device is a wireless data access-enabled device (e.g., an iPHONE® smart phone, a BLACKBERRY® smart phone, a NEXUS ONE™ smart phone, an iPAD™ device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers (which are web browsers with small file sizes that can accommodate the reduced memory constraints of wireless networks), on other client applications accessed via the graphical displays, on client applications that do not utilize a graphical display, or the like. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on a mobile device, the examples may similarly be implemented on any suitable computing device.

As referred to herein, a “user interface” is generally a system by which users interact with a computing device. An interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, a user interface can be a display window or display object, which is selectable by a user of a mobile device for interaction. The display object can be displayed on a display screen of a mobile device and can be selected by, and interacted with by, a user using the user interface. In an example, the display of the mobile device can be a touch screen, which can display the display icon. The user can depress the area of the display screen at which the display icon is displayed for selecting the display icon. In another example, the user can use any other suitable user interface of a mobile device, such as a keypad, to select the display icon or display object. For example, the user can use a track ball or arrow keys for moving a cursor to highlight and select the display object.

Operating environments in which embodiments of the present disclosure may be implemented are also well-known. In a representative embodiment, a computing device, such as a mobile device, is connectable (for example, via WAP) to a transmission functionality that varies depending on implementation. Thus, for example, where the operating environment is a wide area wireless network (e.g., a 2.5G network, a 3G network, or a 4G network), the transmission functionality comprises one or more components such as a mobile switching center (MSC) (an enhanced ISDN switch that is responsible for call handling of mobile subscribers), a visitor location register (VLR) (an intelligent database that stores on a temporary basis data required to handle calls set up or received by mobile devices registered with the VLR), a home location register (HLR) (an intelligent database responsible for management of each subscriber's records), one or more base stations (which provide radio coverage with a cell), a base station controller (BSC) (a switch that acts as a local concentrator of traffic and provides local switching to effect handover between base stations), and a packet control unit (PCU) (a device that separates data traffic coming from a mobile device). The HLR also controls certain services associated with incoming calls. Of course, the present disclosure may be implemented in other and next-generation mobile networks and devices as well. The mobile device is the physical equipment used by the end user, typically a subscriber to the wireless network. Typically, a mobile device is a 2.5G-compliant device or 3G-compliant device or a 4G-compliant device that includes a subscriber identity module (SIM), which is a smart card that carries subscriber-specific information, mobile equipment (e.g., radio and associated signal processing devices), a user interface (or a man-machine interface (MMI)), and one or more interfaces to external devices (e.g., computers, PDAs, and the like). The mobile device may also include a memory or data store.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

### Non-Limiting Definitions

As used herein, the term “training session” may refer to an active course that is currently being taken by users or individuals such as, students. The term “performance gap” may refer to a job performance issue that can be solved with a change in “knowledge,” “skill,” and “attitude” of a user or subject such as, a training candidate.

The term “mastery test” may refer to a test developed to capture proficiency of specific knowledge and skills required for closing the performance gap. The mastery test is the criteria for success, which is tracked throughout the process.

The term “post-test passing percentage” may refer to percentage needed to pass the post-test, which may be administered after the training course. The term “transfer test passing percentage” may refer to percentage or score needed to pass the transfer-test, which may be administered several weeks, or months, after the training course and post-test. Further, the term “post to transfer acceptable percent drop” may refer to allowable percentage decrease between post-test score and transfer test score, which may be calculated after transfer scores are entered.

Further, the term “attitude” may refer to a manner in which people evaluate, appreciate, or make value-judgments. The term “drop down menu/list” may refer to a data entry tool that may allow the user to select previously entered data. The term “training transfer” may refer to a determination whether the evaluation group of candidates has had an opportunity to use their newly obtained knowledge and skills on the job.

Further, as used herein, the term “measurable objectives” may refer to outcomes presented in precise and concise terms, the exact observable results to be attained allowing for a consistent and repeatable result. The measurable objectives may include at least three parts: “Observable Action,” “At least one Measurable Criterion,” and “Conditions of Performance”.

Disclosed herein are the embodiments of systems (or a content management system) and methods that may facilitate a user, such as a human resource professional, a teacher, a professor, a trainer, and so forth, to create and evaluate measurable training content. The disclosed systems and methods enables the user to design and execute training programs, courses, course content, evaluation tests, and the like. Further, some embodiments of the disclosed systems and methods may guide the user, such as the training professionals, through a robust design/evaluation process and provide executive management with material evidence of learning's value. Some embodiments of the present disclosure also facilitate the user to develop or create an instructional plan for conducting the training of one or more training candidates. The disclosed systems and methods may also be used by the user to create mastery test for evaluating the skills of the training candidates which may be applied before the start of training, immediately after training completion, and/or sometime after training completion to measure retention.

Embodiments of the present disclosure may also facilitate the implementation of training assessment by helping educators, trainers, human resource professionals, other business professionals, and the like to complete the necessary steps to enable the development of effective measurable training programs.

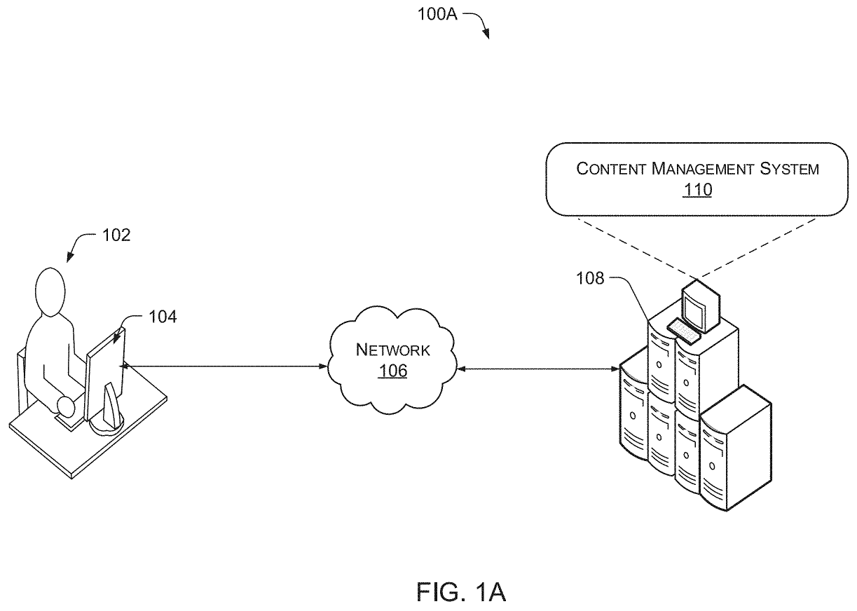

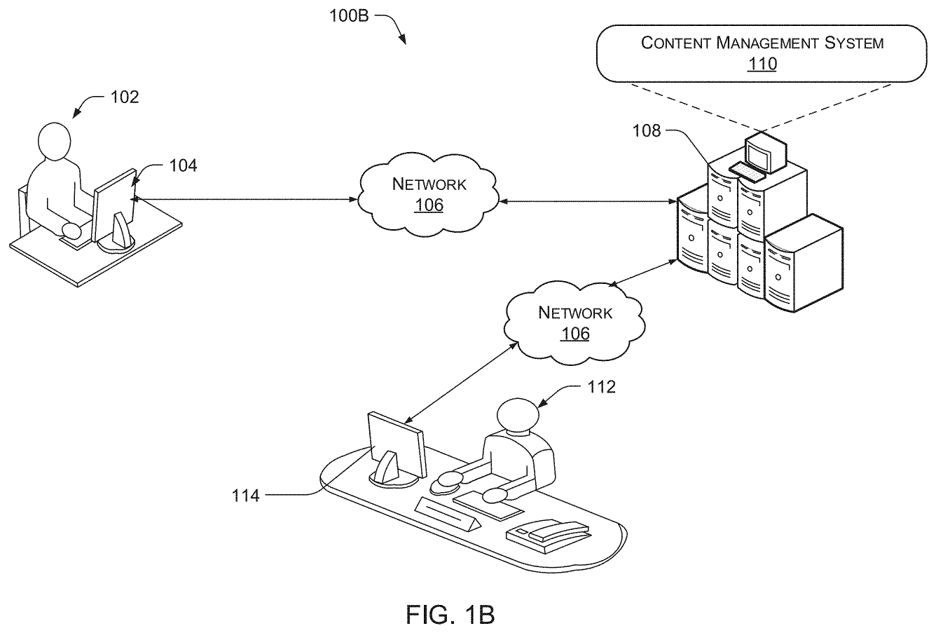

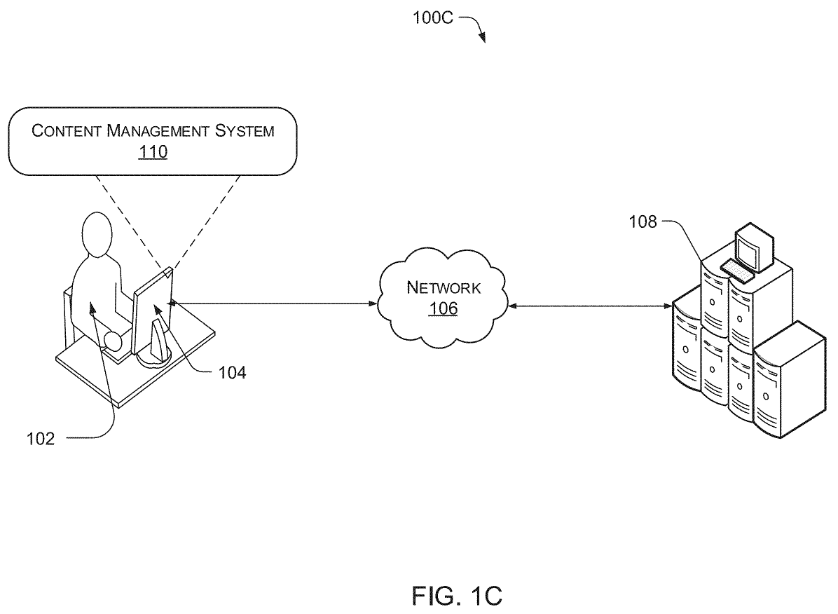

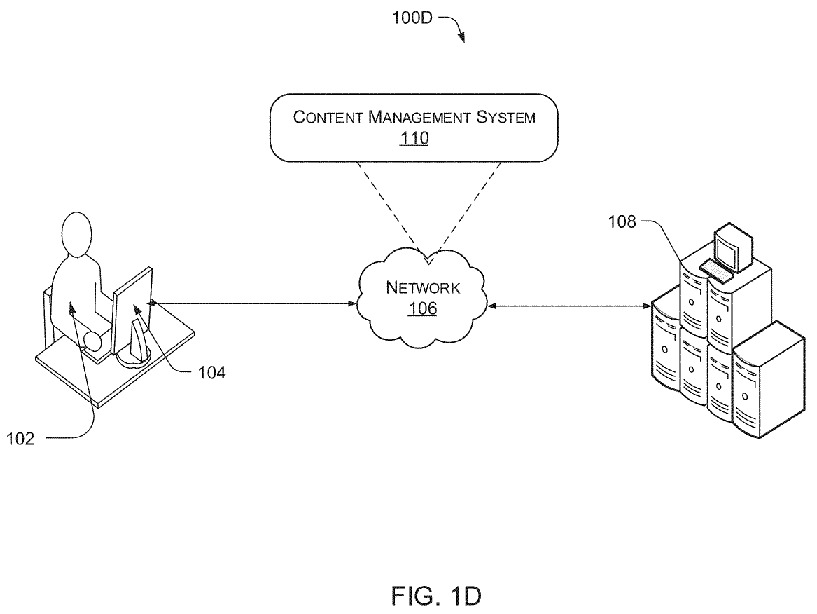

FIGS. 1A-1D illustrate schematic diagrams of example environments 100A-100D including a content management system 110 within which various embodiments of the present disclosure may function. Referring now to FIG. 1A, the environment 100A may primarily include a user 102, a communications network 106, and a server 108. The user 102 can be a trainer, a teacher, a human resource (HR) professional, a professor, administrators, managers, reviewers, or the like. Further, the user 102 may have an associated computing device 104 being configured to connect or communicate with the server 108 through the network 106. For example, the user 102 can access the system via the Internet. Examples of the computing device 104 may include, but are not limited to, a server, a desktop PC, a notebook, a workstation, a personal digital assistant (PDA), a mainframe computer, a tablet computer, a laptop computer, a smart phone, a mobile computing device, an internet appliance, and the like. The computing device 104 may be configured to exchange at least one of text messages, audio interaction data (for example, voice calls, recorded audio messages, or the like), and video interaction data (for example, video calls, recorded video messages, etc.) or a combination of these with the server 108, or in any combination.

The network 106 may be a wireless or a wired network, or a combination thereof. The network 106 may be a collection of individual networks, interconnected with each other and functioning as a single large network (e.g., the Internet or an intranet). Examples of the network 106 may include, but are not limited to, a local area network (LAN), a wide area network (WAN), a personal area network (PAN), a cable/telephone network, a satellite network, and the like.

The server 108 may connect to the computing device 104 over the network 106. The server 108 may be implemented as a specialized computing device implementing the embodiments. Alternatively, the server 108 may be implemented using any of a variety of computing devices including, for example, multiple networked servers (arranged in clusters or as a server farm), a mainframe, or so forth.

The server 108 may include the content management system 110 for assisting the user 102 in quantifying the level of knowledge, skill, or attitude changes gained by training candidates, such as students, employees, from a training session. The content management system 110 can be a software application, hardware, a firmware, or combination of these. Further, the server 108 may include one single computer or multiple computers, computing devices, or the like.

The content management system 110 may be configured to create measurable objectives based on the training goals identified by the user 102. The user 102 may take inputs from other users to identify the training goals. Hereinafter, throughout the disclosure, the terms “training goals” and “learning goals” may be used interchangeably without changing their meaning. The content management system 110 may also be configured to create or develop a mastery test for evaluation of the training candidate based on inputs from the user 102 and a set of evaluations for a learning goal of a learning program. Throughout this disclosure, the terms assessment, mastery test, and evaluation test may be used interchangeably without changing their meaning. The assessment may happen before the training session, after the training session or both. The learning goal (or training goal) may be an identification of a performance gap between an actual work performance metric and an expected work performance metric. The learning goal may identify a performance goal to achieve during the training session to reduce the performance gap metric. Further, the content management system 110 may be configured to present a mastery test of the learning program to the user 102 during a training session. The content management system 110 may also be configured to determine a performance metric associated with the learning goal after completion of the mastery test during the training session. The content management system 110 may further be configured to determine a learning assessment metric based on the performance metric after the completion of the training session. The content management system 110 may also be configured to communicate the learning assessment metric to a computing device, such as the computing device 104, after the completion of the training session. The learning assessment metric may include scores.

In some embodiments, the learning assessment metric or a summary including the evaluation may be sent to other users for review. Referring now to FIG. 1B, the environment 100B may include a second user 112. The second user 112 can be a trainer or business manager, or the like. In an exemplary scenario, the learning assessment metric or the summary may be presented to the second user 112 on an associated second computing device 114. The second user 112 may also access the content management system 110 on his or her second computing device 114 via the network 106. In an exemplary scenario, the user 102 can be a business manager and the second user 112 can be an HR professional helping the HR professional to identify learning goals, performance objectives, and/or the like.

Referring now to FIG. 1C, in one embodiment, the content management system 110 may be present on the computing device 104. For example, the content management system 110 may be integrated with the computing device 104. The user 102 can access the content management system 110 directly on the computing device 104. The content management system 110 may be a software application, hardware, or combination of these present or residing on the computing device 104. The user 102 may enter his or her associated login credentials such as, but not limited to, login identity, password, company name, designation, employee identity, and/or the like for logging into the content management system 110.

In one embodiment, the network 106 may be established using a network appliance (not shown) that may be integrated with the content management system 110. In other embodiments, the network appliance may be preconfigured or dynamically configured to include the content management system 110 integrated with other devices as shown in FIG. 1D. The computing device 104 may include a device (not shown) that enables the computing device 104 being introduced to the network appliance, thereby enabling the computing device 104 to invoke the content management system 110 present on the network appliance as a service. Examples of the network appliance may include, but are not limited to, a DSL modem, a wireless access point, a router, and a gateway for implementing the content management system 110. In some embodiments, the user 102 (and the second user 112) may access the content management system 110 by using a suitable web browser on the computing device 104. Examples of the web browser may include, but are not limited to, Internet Explorer, Google Chrome, Firefox Mozilla, and the like.

The content management system 110 may represent any of a wide variety of devices that provide services for the network 106. The content management system 110 may be implemented as a standalone and dedicated “black box” including specialized hardware with a processor and memory programmed with software, where the hardware is closely matched to the requirements and/or functionality of the software. The content management system 110 may enhance or increase the functionality and/or capacity of the network 106 to which it is connected. The content management system 110 may be configured, for example, to perform e-mail tasks, security tasks, network management tasks including IP address management, and other tasks. In some embodiments, the content management system 110 is configured not to expose its operating system or operating code to an end user, and does not include related art I/O devices, such as a keyboard or display. The content management system 110 of some embodiments may, however, include hardware, software, firmware or other resources that support remote administration and/or maintenance of the content management system 110.

The content management system 110 may be configured to design course material, evaluations, or the like for one or more measurable training programs. In a measurable training program, the measurement may include a repeatable process for quantifying the level of knowledge, skill, or attitude changes gained from a training event. The measurement may also include quantifying the knowledge, skill, or attitude changes gains (or losses) over a period of time after a training event in order to determine learning retention in the students or training candidates. The measurable training program may require the creation of quantifiable learning objectives that directly link to job requirements, instructional strategies, and assessments of student's learning. These may be called as measurable objectives. The measurable objectives may include the following components: specific knowledge, skill, or attitude to be learned, level to which the learning should occur. The measurable objectives may be based on an existing learning classification framework such as Bloom's Taxonomy, which lists learning levels and their associated learning verbs. Further, the measurable objective may include at least three parts: “Observable Action,” “At least one Measurable Criterion,” and “Conditions of Performance”. Examples of the condition under which desired results may be performed may include, but are not limited to, in front of at least one observer, within the time limit of 60 seconds, and so forth. Examples of the criteria for determining how well and when the behavior is to be performed may include, but are not limited to, with no error, after completing the training program, and the like.

The content management system 110 along with the user 102 may determine the specific conditions under which the learner such as the training candidates (for example, students, employees, or the like) should be able to demonstrate the learning indicated in the measurable objective. Further, the content management system 110 may be configured to determine the specific criteria to which the learner (or the training candidate) should demonstrate mastery of the learning indicated in the measurable objective.

The content management system 110 may be configured to encapsulate or store the particular learning required, the conditions under which the learning must be demonstrated, and the criteria for assessing learning success enables a training designer to easily identify appropriate instructional strategies and create learning assessments (mastery questions used to quantify the learning gains). The content management system 110 may be configured to link job requirements, instructional strategies, and learning assessments through the measurable objectives for enabling repeatable results and ensuring impact against job performance of the training candidates.

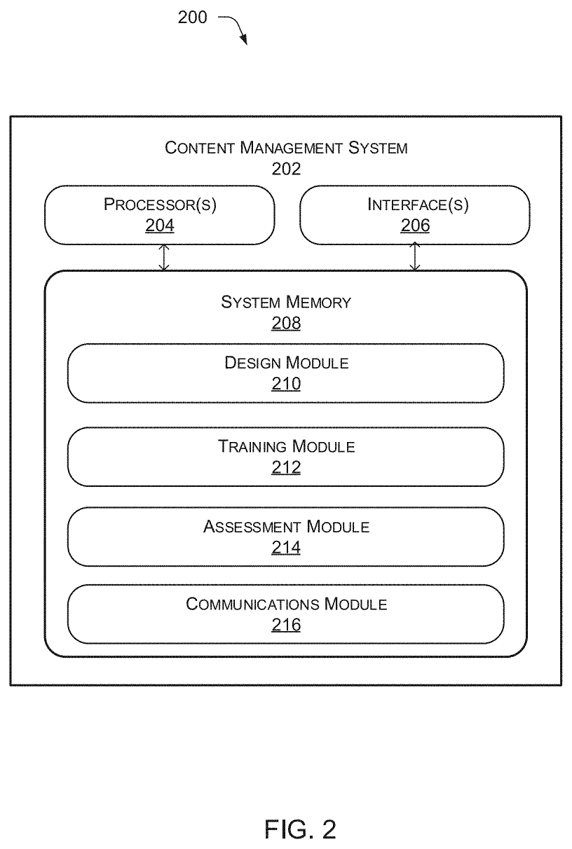

FIG. 2 illustrates a block diagram 200 of example system elements of a content management system 202 in accordance with an embodiment of the present disclosure. The system 202 may be implemented as one or more computing devices. The content management system 110 may include one or more processors 204, one or more user interfaces 206, and a system memory 208. The system memory 208 may further include a design module 210, a training module 212, an assessment module 214, and a communications module 216. Though not shown, but the content management system 216 may also include a database for storing and maintaining information such as, but not limited to, the conditions, criteria, comprehension levels, evaluation types, mastery test, evaluation plans, course material, evaluation questions, evaluation answers, scores, pre-defined score thresholds, and the like. Further, the database may store the information using suitable data structures, such as tree data structure, linked lists, graphs, arrays, and the like.

The content management system 202, in one or more embodiments, may be a hardware device with at least one processor 204 executing machine readable program instructions for creating measurable objectives, design course content, mastery tests, evaluation plan, instruction plan for training, and the like. The content management system 202 may include, in whole or in part, a software application working alone or in conjunction with one or more hardware resources. Such software applications may be executed by the processors 204 on different hardware platforms or emulated in a virtual environment.

The processor(s) 204 may include, for example, microprocessors, microcomputers, microcontrollers, digital signal processors, central processing units, state machines, logic circuits, and/or any devices and computer memory that manipulate signals based on operational instructions. Among other capabilities, the processor(s) 204 may be configured to fetch and execute computer readable instructions.

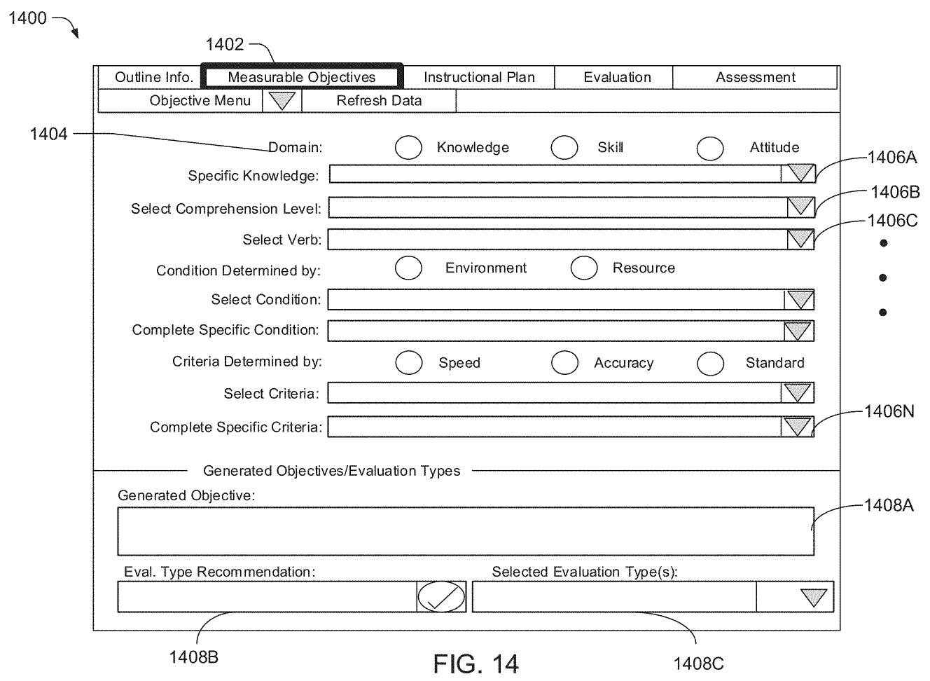

The interface(s) 206 may include a variety of software interfaces, for example, application programming interface (API); hardware interfaces, for example, cable connectors; or both. An example interface is described in detail with reference to FIG. 14. As discussed with reference to FIGS. 1A-1D, the interface(s) 206 may facilitate inputs from the user 102, the second user 112, or others. The interface(s) 206 may further facilitate reliably transmission of one or more information, such as a mastery test, to the server 108. The interface(s) 206 may be configured to present a mastery test of a learning program during a training session. The mastery test may be presented on a suitable user interface (not shown) of the computing device 104.

The design module 210 may include one or more processors and a memory. The design module 210 may be a hardware device and may be configured to create a measurable learning design for achieving a learning goal. The learning goal may include an identification of a performance gap metric between an actual work performance metric and an expected work performance metric. For example, the learning goal may include an identification of a performance gap metric between an actual work performance metric and an expected work performance metric of a training candidate for example, an employee of a corporate organization. The learning goal may be identified or created by the user 102 (for example, an HR professional) based on a GAP analysis. In an exemplary scenario, the HR professional may perform the GAP analysis to identify the learning goal(s). Further, the learning goal identifies a performance goal to achieve during the training session to reduce the performance gap metric. The design module 210 may further be configured to receive, via the interface(s) 206, an input from the user 102 to generate the one or more measurable objectives that address the performance gap. In some embodiments, the user 102 may select the domain associated with the measurable objectives. The domain may include a knowledge, skill, or attitude associated with the learning goal. In alternative embodiments, the input includes a selection of a comprehension level associated with the selected domain. In further embodiments, the input includes a selection of a verb associated with the selected domain. Further, the input may include a selection of a condition associated with the learning goal. The condition may include an environment, and resource associated with the learning goal. Furthermore, the input may include a selection of criteria associated with the learning goal. The criteria may include at least one of a speed, accuracy, or standard criteria associated with the learning goal. Further, the measurable objective may include at least three parts: “Observable Action,” “At least one Measurable Criterion,” and “Conditions of Performance”. Examples of the condition under which desired results may be performed may include, but are not limited to, in front of at least one observer, within the time limit of 60 seconds, and so forth. Examples of the criteria for determining how well and when the behavior is to be performed may include, but are not limited to, with no error, after completing the training program, and the like. The design module 210 may also be configured to determine the set of evaluations based on one or more measurable objectives of the learning goal.

Further, the design module 210 may be configured to recommend an evaluation type based on the generated one or more measurable objectives. Examples of the evaluation type may include, but are not limited to, for “Knowledge domain”: multiple choice, true/false, checklist, essay, and open ended questions; for “Skill domain”: scenario, model behavior-role play, demonstration/observation, simulation, and expert mentoring; for “Attitude domain”: scenario, demonstration/observation, model/behavior-role play, debate/observation, survey, and the like. The design module 210 may also be configured to determine the set of evaluations based on the recommended evaluation type. Further, the design module 210 may be configured to determine an instructional strategy based on an instructional method selected from a list of instructional methods. In some embodiments, the user 102 (or the second user 122) may select the instructional method from the list of instructional methods stored in a database (not shown) of the content management system 110. The design module 210 may be further configured to determine the list of instructional methods from the selected domain associated with the one or more measurable objectives. The domain may be selected by the user 102 (or the second user 112). The design module 210 may further be configured to create the mastery test from the determined instructional strategy.

The training module 212 may include at least one processor and a memory. The training module 212 may be a hardware device and may be configured to determine a performance metric associated with the learning goal after completion of the mastery test during the training session. The training module may be further configured to present the mastery test prior to a training event during the training session via the interface 206. Further, the training module 212 may be configured to receive inputs during the presentation of the mastery test prior to the training session or event. The inputs may be received via the interface(s) 206. The training module 212 may be configured to compare the inputs received during the presentation of the mastery test to the set of evaluations of the mastery test. Further, the training module 212 may be configured to determine a pre-training metric based on the comparison of the received inputs and the set of evaluations of the mastery test.

The training module 212 may be also configured to present the mastery test after a training event during a training session via the interface(s) 206. The training module 212 may be further configured to receive inputs during the presentation of the mastery test after the training event. The inputs may be received via the interface(s) 206. The training module 212 may also be configured to compare the inputs received during the presentation of the mastery test after the training event to the set of evaluations of the mastery test. The training module may also be configured to determine a post-training metric (or score) based on the comparison of the received inputs and the set of evaluation of the mastery test.

In some embodiments, the training module 212 may be configured to present the mastery test at a period of time after a training event during the training session via the interface(s) 206. The training module 212 may also receive inputs during the presentation of the mastery test a period of time after the training event. The inputs may be received via the interface(s) 206. The training module 212 may also compare the inputs received during the presentation of the mastery test at the period of time after the training event to the set of evaluation of the mastery test. The training module 212 may further determine a transfer-training metric based on the comparison of the received inputs and the set of evaluations of the mastery test.

In some embodiments, the training module may be configured to determine the performance metric based on the pre-training metric, the post-training metric, and the transfer-training metric. The training effect metric may quantify the effectiveness of the learning program during the training session

The assessment module 214 of the content management system 202 may further include at least one processor and a memory. The assessment module 214 may be a hardware device and may be configured to determine a learning assessment metric based on the performance metric after the completion of the training session.

The communications module 216 of the content management system 202 may further include at least one processor and memory. The communications module 216 may be a hardware device and may be configured to communicate the learning assessment metric to the computing device of the user 102 via the interface 206 after the completion of the training session.

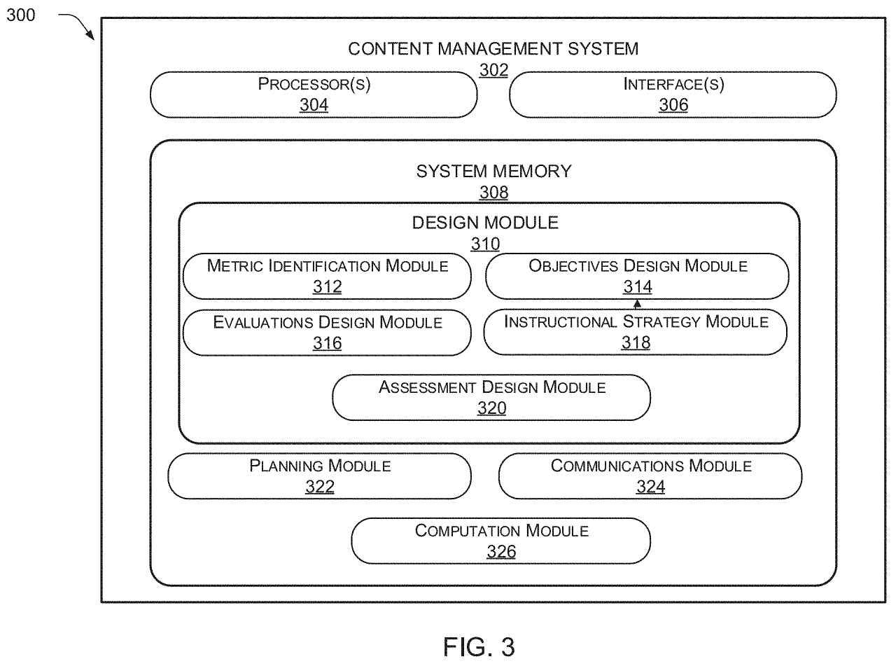

FIG. 3 illustrates a block diagram 300 of example system elements of another exemplary content management system 302 in accordance with another embodiment of the present disclosure. The content management system 302 may include one or more processors 304, one or more interface(s) 306, and a system memory 308. The system memory 308 may also include a design module 310, a planning module 322, a communications module 324, and a computation module 326.

The content management system 302, in one or more embodiments, may be a hardware device with at least one processor 304 executing machine readable program instructions for creating measurable objectives, design course content, mastery tests, or the like. Such a system may include, in whole or in part, a software application working alone or in conjunction with one or more hardware resources. The software application may be executed by the processors 304 on different hardware platforms or emulated in a virtual environment.

The processor(s) 304 may include, for example, microprocessors, microcomputers, microcontrollers, digital signal processors, central processing units, state machines, logic circuits, and/or any devices and computer memory that manipulate signals based on operational instructions. Among other capabilities, the processor(s) 304 may be configured to fetch and execute computer readable instructions.

The interface(s) 306 may include a variety of software interfaces, for example, application programming interface; hardware interfaces, for example, cable connectors; or both. As discussed with reference to FIGS. 1A-1D, the interface(s) 306 may facilitate inputs from the user 102, user 112 etc. The interface(s) 306 may further facilitate reliably transmitting one or more information such as mastery test to the server 108. The interface(s) 306 may be configured to present a mastery test of a learning program during a training session. The mastery test may be presented on a user interface (not shown) of the computing device 104.

The design module 310 may further include a metric identification module 312, an objective design module 314, an evaluations design module 316, an instructional strategy module 318, and an assessment design module 320. The design module 310 may be a hardware device and may also include at least one processor and memory. The design module 310 may be configured to create a measurable learning design intended to influence a specific metric (or metrics) by identifying the specific behaviors that affect the metric(s) and developing the metric(s) into measurable learning objects such that performance against the metric(s) can be measured at the individual behavior level.

The metric identification module 312 may be a hardware device and may be configured to identify the metric(s) intended to be influenced by the learning program. The objectives design module 314 may be a hardware device and may be configured to create individual measurable objectives for the identified specific behaviors. The evaluations design module 316 may be a hardware device and may be configured to create one or more evaluations for each of the measurable objectives.

The instructional strategy module 318 may be a hardware device and may be configured to create a learning strategy for one or more measurable objectives such that the identified behaviors are acquired. The learning strategy may be directly linked to the type of measurable objectives (or training objectives) of the course to achieve maximum learning impact.

The assessment design module 320 may be a hardware device and may be configured to create an assessment instrument (mastery test) using the created set of evaluations such that the assessment instrument can be delivered to students attending the learning program, and provide a quantification of their learning achievement. The mastery test may measure each learner's specific learning performance for against measurable objective. Further, the mastery test may include one or more questions.

The planning module 322 may be a hardware device and may be configured to identify the specific students or training candidates to receive the training, to schedule the learning timeline (i.e. pre, post, and transfer dates), and to capture both metric and student performance data at multiple points along the learning timeline.

The communications module 324 may be a hardware device and may be configured to deliver learning assessments to identified training candidates, such as the students, and capture the performance of the training candidates on said learning assessment.

The computation module 326 may be a hardware device and may be configured to calculate learning performance against the specific behaviors at both the individual (for example, at student) and group (for example, at class) levels, to calculate performance changes between points along the learning timeline, and to correlate the results to observed changes in the metric (or metrics) intended to be affected by the learning design. In some embodiments, the content management system 302 may include more modules than shown in FIG. 3.

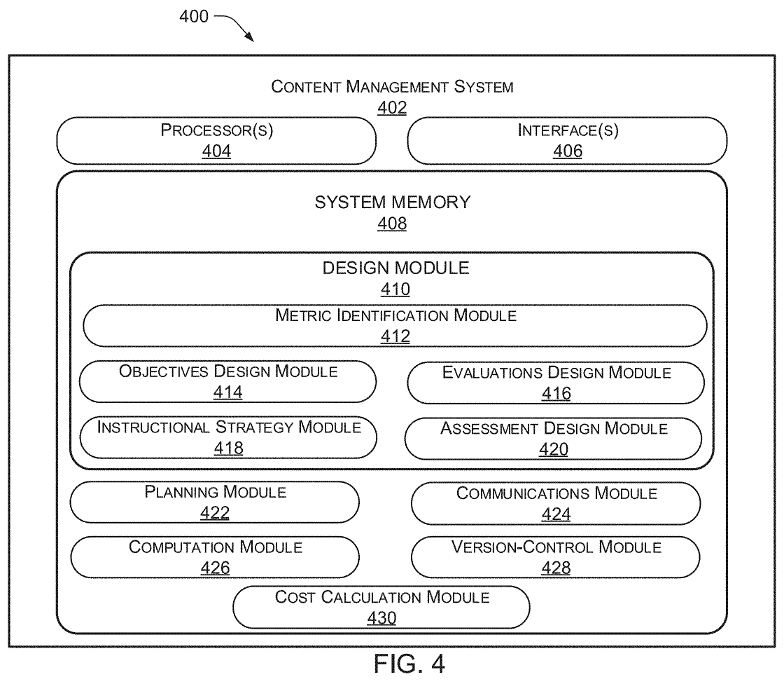

FIG. 4 illustrates a block diagram 400 of example system elements of a content management device 402 in accordance with embodiments of the present disclosure. It is noted that functionality of the system may be implemented as one or more computing devices. Referring to FIG. 4, the content management device 402 may include one or more processors 404, interface(s) 406, and a system memory 408. The system memory 408 may also include a design module 410 that may further include a metric identification module 412, an objectives design module 414, an evaluations design module 416, an instructional strategy module 418, and an assessment design module 420. The design module 410, the metric identification module 412, the objectives design module 414, the evaluations design module 416, the instructional strategy module 418, and the assessment design module 420 are structurally and functionally similar to the design module 310, the metric identification module 312, the objectives design module 314, the evaluations design module 316, the instructional strategy module 318, and the assessment design module 320 as described with reference to FIG. 3.

The system memory 408 may further include a planning module 422, a communications module 424, a computation module 426, a version-control module 428, and a cost calculation module 430. The planning module 422, the communications module 424, and the computation module 426 may be similar in structure and function of the planning module 322, the communications module 324, and the computation module 326 of the content management system 302 as discussed with reference to FIG. 3.

The version-control module 428 may be a hardware device and may be configured such that prior performance against a learning design may be incorporated into future changes for ongoing improvement. The cost calculation module 430 may be a hardware device and may be configured to calculate the cost of both design and evaluation.

As discussed with references to FIGS. 2, 3, and 4, initially, a gap (difference) between actual work performance and expected work performance by a group of one or more persons (such as students, employees, or the like) within an organization (for example, a school, a company, or the like) may be identified by the user 102, and this gap may be referred to as the performance gap. The performance gap may be identified or recognized by a measured business performance metric not being achieved to a satisfactory level. The user 102 may then work with a training designer, such as the second user 112, (See FIG. 1B) to develop an initial set of goals intended to address the performance gap. In an exemplary scenario, the business manager may be the user 102 and can work with the training designer to develop an initial set of learning goals intended to address the performance gap.

The training designer or the second user 112 may also perform a gap analysis to verify the appropriateness of the learning goals. This gap analysis may focus on what the group including the students or employees is actually doing, and what they should be doing. The gap analysis may be carried out through one or more of the following: “job analysis”, “task analysis”, and “content analysis”. In job analysis, the second user 112 (or the user 102) may create a detailed description of the job requirements. In task analysis, the user 102 or the second user 112 may create a detailed description of tasks required on the job. Similarly, in content analysis, the user 102 or the second user 112 may create a detailed description of content of subject or subjects applicable to the intended goals.

After performing the job analysis, the task analysis and the content analysis, the user 102 and/or the second user 112 may revise the learning goals as necessary to align with the results of the job analysis, task analysis, and content analysis. The user 102 or the second user 112 then may evaluate if the revised learning goals can be achieved with knowledge, skill, or attitude improvement. If yes, then the training development process continues and the content management system 110 may develop the training material, evaluation tests, instruction plan, instruction strategy, and so forth based on one or more inputs from the user 102 and/or second user 112. The inputs may include learning goals, performance objectives, selection of a criteria associated with the learning goal, a selection of a domain, a selection of a comprehension level associated with the selected domain, selection of a condition associated with the learning goal, (as discussed above), and so forth. The criteria may include at least one of a speed, accuracy, or standard criteria associated with the learning goal. Further, the condition may include at least one of an environment and resource associated with the learning goal. If the user 102 or the second user 112 evaluates that the revised learning goals cannot be achieved with knowledge, skill, or attitude improvement then solutions other than training may be pursued.

Once it is determined that training needs to be developed, the user 102 and/or the second user 112 may work together to determine performance objectives, which may identify the knowledge, skill, or attitude gains that may be needed to achieve the revised learning goals. The user 102 and/or the second user 112 may determine or evaluate answers to some specific questions. Examples of the specific questions may include, but are not limited to, what the group or training candidate need to know, what group or training candidate need to be able to do, and so forth.

The user 102 and/or the second user 112 may organize the performance objectives under the learning goals into logical topic groups. The content management system 110 (202-402) may refine the performance objectives into measurable objectives based on one or more inputs from the user 102 (or the second user 112). The measurable objectives may define expected behavior, the conditions under which the behavior must be achieved, and criteria which must be met for success.

The second user 112 (or the user 102) may determine answer to one or more questions in preparation for measurable objective creation. The questions can be such as, but not limited to, what things will you be looking for to see that this objective has been met?, what does success look like to you?, what things will you be looking for to see that the employee has accomplished the objective?, what are the circumstances where the student will have to perform this task on the job?, and so forth.

The second user 112 (or the user 102) may refine the above responses into specific items used in measurable objective creation by answering the questions such as, but not limited to, what will the learner be doing when they demonstrate mastery of the objective?, at what level must the learner perform in order for their performance to be acceptable?, using what tools, or under what circumstances is the learner (or the training candidate) expected to complete the behavior successfully?, and so forth. The process for creating measurable objectives is described in detail with reference to subsequent figures.

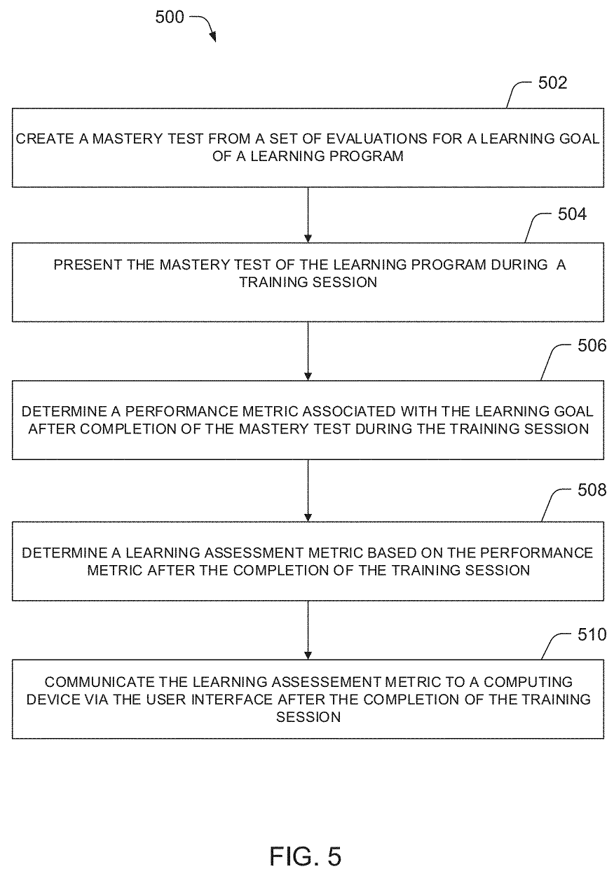

FIG. 5 illustrates a flowchart of an exemplary method 500 for determining a learning assessment metric in accordance with an embodiment of the present disclosure. As described with reference to FIG. 1, the content management system 110 can receive one or more inputs from the user 102. Based on the received inputs, the content management device 110 can develop training content, course, evaluation tests such as mastery tests, instruction plan, and so forth. As discussed with reference to FIG. 2, the content management system 110 or 202 may include many modules.

At step 502, a mastery test is created from a set of evaluations for a learning goal of a learning program. In some embodiments, the assessment module 214 may create the mastery test from the set of evaluations for the learning goal of the learning program. The learning goals may be identified and may be entered by the user 102. The content management system 110 (or 202) may store the learning goals in the database of the content management system 110.

At step 504, the mastery test of the learning program may be presented during a training session. A training session may refer to a session in which a part or complete training course is presented to one or more training candidates. The mastery test may be presented on the interface 206. The mastery test may measure each learner's (or training candidate's) specific learning performance for against measurable objective.

Further, at step 506, a performance metric associated with the learning goal may be determined after completion of the mastery test during the training session. In some embodiments, the training module 212 determines a performance metric associated with the learning goal after completion of the mastery test during the training session. Then at step 508, a learning assessment metric may be determined based on the performance metric after the completion of the training session. In some embodiments, the assessment module 214 determines the learning assessment metric based on the performance metric after the completion of the training session. Thereafter at step 510, the learning assessment metric may be communicated to a computing device, such as the computing device 104, via the interface 206 after the completion of the training session. In some embodiments, the communications module 216 communicates the learning assessment metric to the computing device 104 via the interface 206 after the completion of the training session.

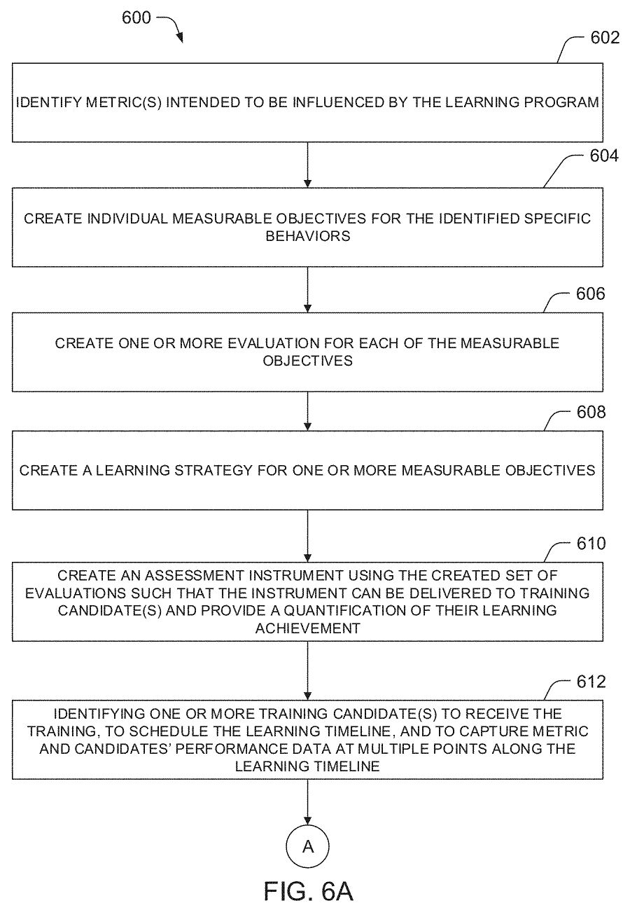

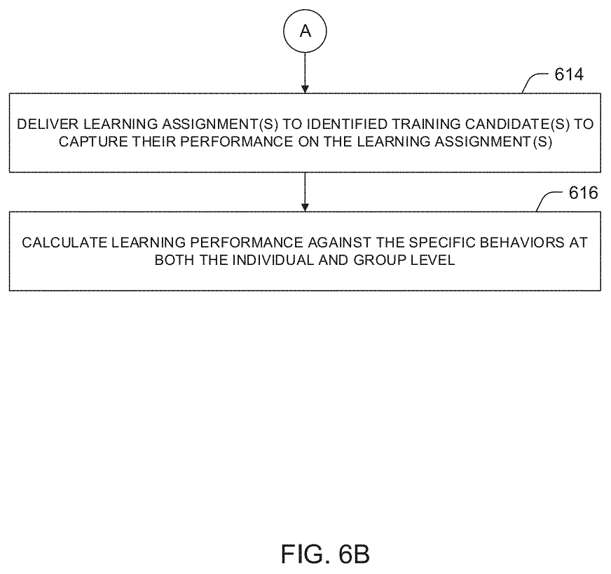

FIGS. 6A and 6B illustrates a flowchart of an exemplary method 600 for calculating a learning performance of one or more training candidates in accordance with an embodiment of the present disclosure. As discussed with reference to FIG. 3, the content management system 302 includes the processor(s) 304, the interface(s) 306, and the system memory 308 including the multiple modules. The system memory 308 may include the design module 310, the planning module 322, the communications module 324, and the computation module 326.

At step 602, one or more metric(s) that are intended to be influenced by the learning program may be identified. At step 604, individual measurable objectives for the identified specific behaviors may be created. Further, the measurable objectives may include at least three parts: “Observable Action,” “At least one Measurable Criterion,” and “Conditions of Performance”. Examples of the condition under which desired results may be performed may include, but are not limited to, in front of at least one observer, within the time limit of 60 seconds, and the like. Examples of the criteria for determining how well and when the behavior is to be performed may include, but are not limited to, with no error, after completing the training program, and the like.

Subsequently at step 606, one or more evaluations for each of the measurable objectives may be created. Further at step 608, a learning strategy for one or more measurable objectives may be created such that identified behaviors are acquired.

Subsequently at step 610, an assessment instrument, such as a mastery test, may be created using the created set of evaluations. The assessment instrument may be created such that the assessment instrument can be delivered to training candidates (such as the students) that may attend the learning program (training). The assessment instrument may also provide a quantification of the learning achievement of the training candidates. Further at step 612, one or more of the training candidates may be identified to receive the training to schedule the learning timeline, and to capture both metric and training candidates' performance data at multiple points along the learning timeline.

Subsequently at step 614, learning assignment(s) may be delivered to the identified training candidates to capture their performance on the learning assignments. Thereafter, at step 616, learning performance may be calculated against the specific behaviors at both the individual and group level.

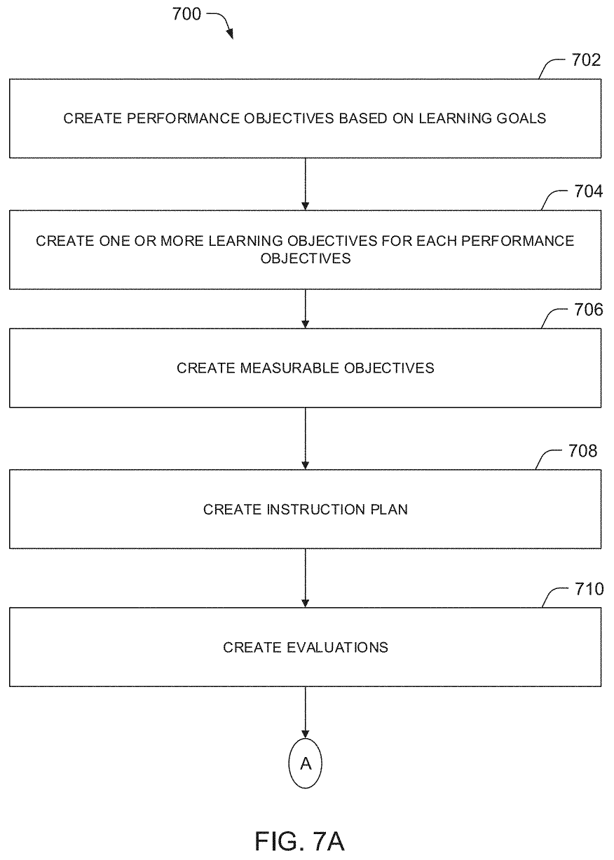

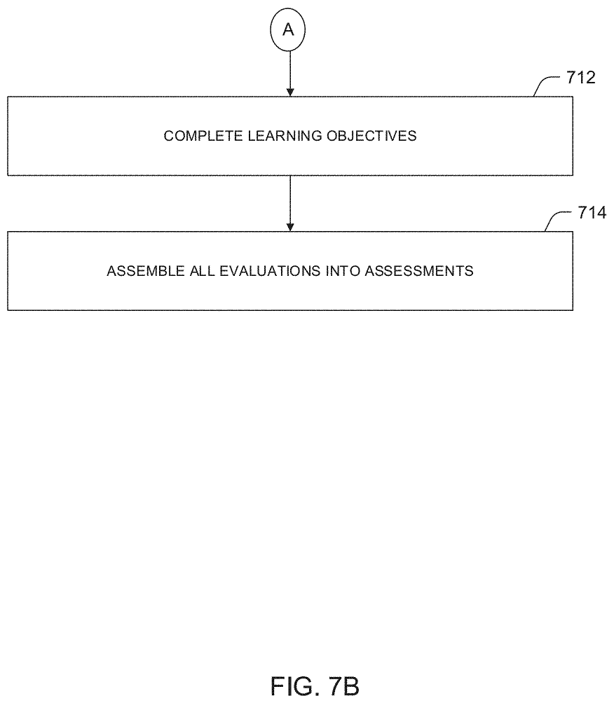

FIGS. 7A-7B illustrates a flowchart of another exemplary method 700 for assessing performance of a training candidate in accordance with another embodiment of the present disclosure. As discussed with reference to FIGS. 1A-1D and FIGS. 2-4, the user 102 can design training course material, training requirement, assessment instrument (mastery test), evaluation plan, instruction strategy, instruction plan, and so forth using the content management system 110 (202, 302, or 402). The content management system 110 may be present on a server, on the computing device 104, on the second computing device 114, on any network appliance in the network 106, on the second computing device 114, and so forth. Further, a gap (difference) between actual work performance and expected work performance by a group of one or more persons (such as students, employees etc.) within an organization (for example a school, a company) may be identified by the user 102, and this gap may be referred to as the performance gap. The performance gap may be identified or recognized by a measured business performance metric not being achieved to a satisfactory level. The user 102 may then work with a training designer, such as the second user 112 (See FIG. 1B), to develop an initial set of goals intended to address the performance gap. In an exemplary scenario, the business manager may be the user 102 and can work with the training designer to develop an initial set of learning goals intended to address the performance gap.

The training designer or the second user 112 may also perform a gap analysis to verify the appropriateness of the learning goals. This gap analysis may focus on what the group including the students or employees is actually doing, and what they should be doing. The gap analysis may be carried out through one or more of the following: “job analysis,” “task analysis,” and “content analysis”. In job analysis, the second user 112 (or the user 102) may create a detailed description of the job requirements. In task analysis, the user 102 or the second user 112 may create a detailed description of tasks required on the job. Similarly, in content analysis, the user 102 or the second user 112 may create a detailed description of content of subject or subjects applicable to the intended goals.

After performing the job analysis, the task analysis and the content analysis, the user 102 and/or the second user 112 may revise the learning goals as necessary to align with the results of the job analysis, task analysis, and content analysis. The user 102 or the second user 112 then may evaluate if the revised learning goals can be achieved with knowledge, skill, or attitude improvement. If yes, then the training development process continues and the content management system 110 may develop the training material, evaluation tests, instruction plan, instruction strategy, and so forth based on one or more inputs from the user 102 and/or second user 112. The inputs may include learning goals, performance objectives, selection of a criteria associated with the learning goal, a selection of a domain, a selection of a comprehension level associated with the selected domain, selection of a condition associated with the learning goal, (as discussed above), and so forth. The criteria may include at least one of a speed, accuracy, or standard criteria associated with the learning goal. Further, the condition may include at least one of an environment and resource associated with the learning goal. If the user 102 or the second user 112 evaluates that the revised learning goals cannot be achieved with knowledge, skill, or attitude improvement then solutions other than training may be pursued.

Once it is determined that training needs to be developed, the user 102 and/or the second user 112 may work together to determine performance objectives, which may identify the knowledge, skill, or attitude gains that may be needed to achieve the revised learning goals. The user 102 and/or the second user 112 may determine or evaluate answers to some specific questions. Examples of the specific questions may include, but are not limited to, what the group or training candidate need to know, what group or training candidate need to be able to do, and so forth.

The user 102 and/or the second user 112 may organize the performance objectives under the learning goals into logical topic groups. The content management system 110 (202-402) may refine the performance objectives into measurable objectives based on one or more inputs from the user 102 (or the second user 112). The measurable objectives may define expected behavior, the conditions under which the behavior must be achieved, and criteria which must be met for success.

The second user 112 (or the user 102) may determine answer to one or more questions in preparation for measurable objective creation. The questions can be such as, but not limited to, what things will you be looking for to see that this objective has been met?, what does success look like to you?, what things will you be looking for to see that the employee has accomplished the objective?, what are the circumstances where the student will have to perform this task on the job?, and so forth.

The second user 112 (or the user 102) may refine the above responses into specific items used in measurable objective creation by answering the questions such as, but not limited to, what will the learner be doing when they demonstrate mastery of the objective?, at what level must the learner perform in order for their performance to be acceptable?, using what tools, or under what circumstances is the learner (or the training candidate) expected to complete the behavior successfully?, and so forth. The process for creating measurable objectives is described in detail with reference to subsequent figures.

At step 702, performance objectives may be created based on one or more learning goals. The learning goals may be identified by the user 102 and/or the second user 112. The learning goal may include an identification of a performance gap metric between an actual work performance metric and an expected work performance metric. Further, the learning goal may identify a performance goal to achieve during the training session to reduce the performance gap metric. In some embodiments, the training module content management system 110 may identify the learning goals based on the inputs from the user 102 (or the second user 112). Further, the content management system 110 may create the performance objectives based on one or more learning goals.

At step 704, one or more learning objectives for each of the performance objectives may be created. The content management system 110 (202, 302, or 402) may create the learning objectives for each of the performance objectives. Then at step 706, measurable objectives may be created such that each of the measurable objectives includes a condition and criteria. The condition may include at least one of an environment and resource associated with the learning goal. The user 102 can choose from the environment or resource condition. By default, the content management system 110 may choose a resource condition for a Knowledge Objective and the environment condition for a Skill Objective and Attitude Objective. The criteria may include at least one of a speed, accuracy, or standard criteria associated with the learning goal. Further, the design module 210 may receive, via the interface 206 (or user interface), an input to generate the one or more measurable objectives. The input may include such as, but not limited to, a selection of a domain associated with the one or more measurable objectives.

At step 708, an instruction plan (instructional plan) may be created by the content management system 110. The design module may create the instruction plan by determining an instructional strategy (or plan) based on an instructional method selected from a list of instructional methods by the user 102 (or 112). The design module 210 may further determine the list of instructional methods from the domain associated with the one or more measurable objectives. The user 102 may select the domain.

At step 710, one or more evaluations may be created by the content management system 110 (or 202). In some embodiments, the design module 210 may create the evaluations in form of one or more mastery test from the determined instruction plan (or instructional strategy). Further, while creating evaluations, each evaluation may be assigned a test points value. There may be three ways to set the test points value: “set questions equal”, “set answers equal”, and “set test points value manually”. In “set questions equal” method, “1” point may be set for each evaluation, effectively making all evaluations of equal points. In “set answers equal” method, “1” point may be set for each possible answer in each evaluation. Some evaluations may have more than one answer, for example—a checklist, and this may assign “1” point for each answer. In “set test point values manually” method, the user 102 may enter the number of test points manually for an evaluation.

At step 712, the learning objective creation may be completed. The design module 210 may complete the learning objective creation. At step 714, the evaluations may be assembled into an assessment. The assessment may be a course assessment, which may be a test used to measure learning for the course. The assessment may be created, organized and scored for assessing the training candidates. The training module 212 may assemble the evaluations into the assessment.

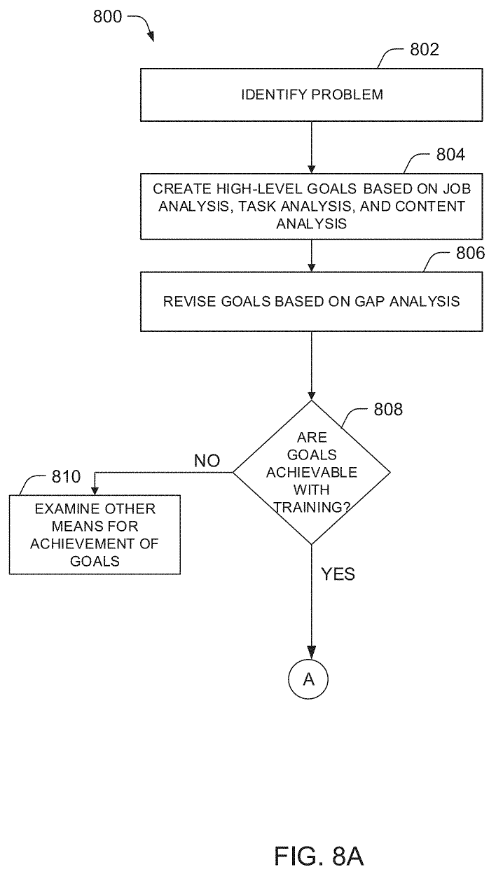

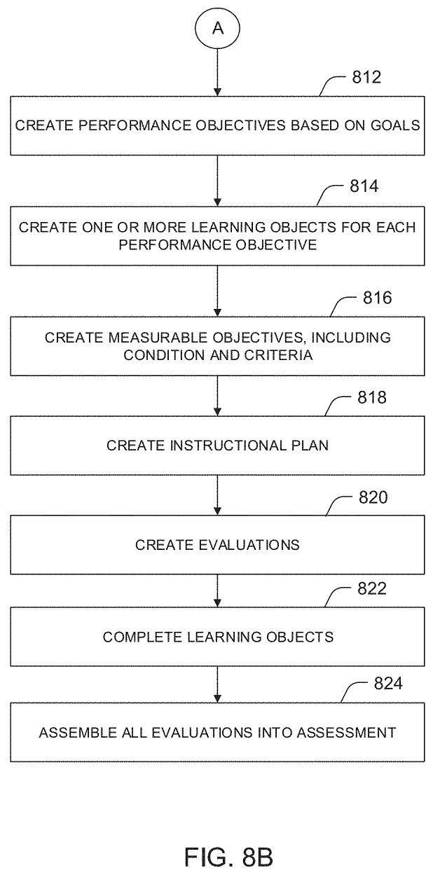

FIGS. 8A and 8B illustrates a flowchart of another exemplary method 800 for assessing performance of a training candidate in accordance with another embodiment of the present disclosure. As discussed with reference to FIGS. 1A-1D and FIGS. 2-4, the user 102 can design training course material, training requirement, assessment instrument (mastery test), evaluation plan, instruction strategy, instruction plan, and so forth using the content management system 110 (202, 302, or 402). The content management system 110 may be present on a server, on the computing device 104, on the second computing device 114, on any network appliance in the network 106, on the second computing device 112, and so forth.

At step 802, a problem may be identified by the user 102. Then, at step 804, the user 102 may create high-level goals (or learning goals) based on “job analysis”, “task analysis”, and “content analysis”. In some embodiments, the user 102 and the second user 112 may collectively create the high-level goals. For example, the business manager and training manager may create the high-level goals together.

Subsequently at step 806, the goals may be revised by the user 102 and/or the second user 112 based on the gap analysis. Thereafter at step 808, it is evaluated whether the revised goals are achievable with training. If yes, then, the process control goes to step 812 else some other means for achieving the goals may be examined at step 810.

At step 812, the content management system 110 may create performance objectives based on the goals (or the learning goals). Then at step 814, one or more learning objects for each of the performance objectives may be created by the content management system 110. At step 816, one or more measurable objectives may be created by the content management system 110. In some embodiments, the objective design module 314 creates the measurable objectives. Each of the measurable objectives may include a condition and a criterion. Then at step 818, an instructional plan may be created by the content management system 110. In some embodiments, the instructional plan is created in form of a learning strategy by the instructional strategy module 316 of the design module 310.

Further at step 820, evaluations may be created by the content management system 110. The evaluations may be created for each of the measurable objectives. In some embodiments, the evaluation design module 316 of the design module 308 creates the evaluations for each of the measurable objectives.

At step 822, learning objects may be completed by the content management system 110 based on the inputs from the user 102. Thereafter, at step 824, all the evaluations may be assembled into an assessment by the content management system 110.

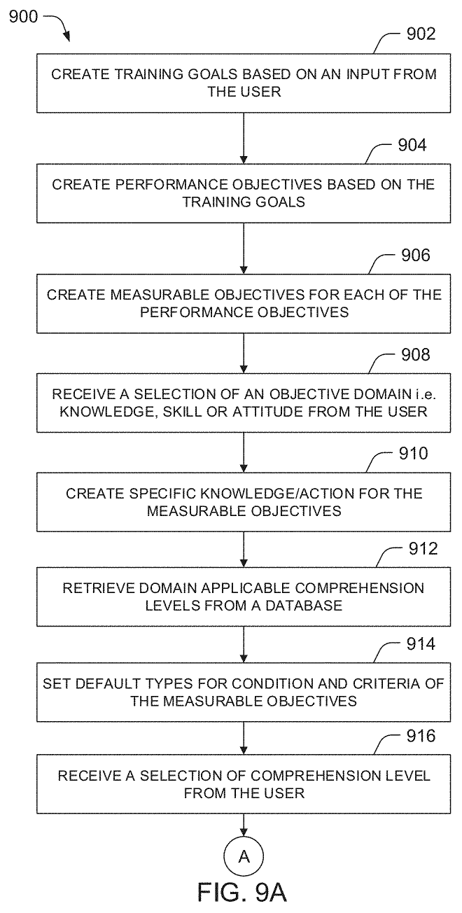

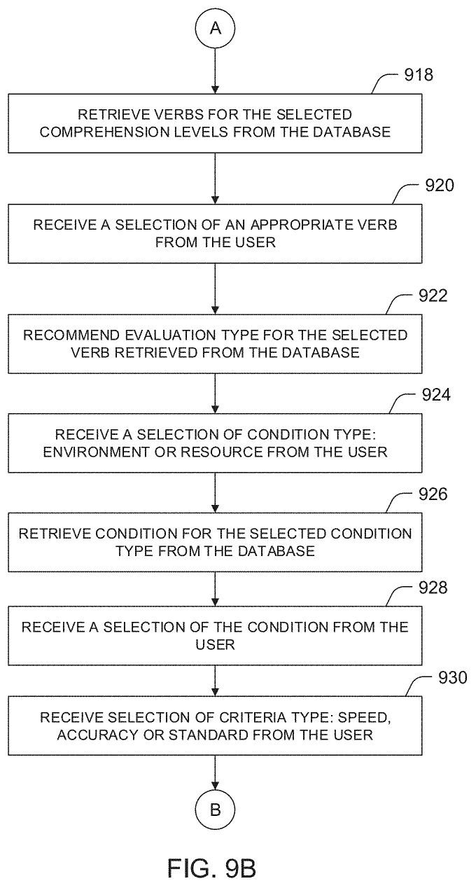

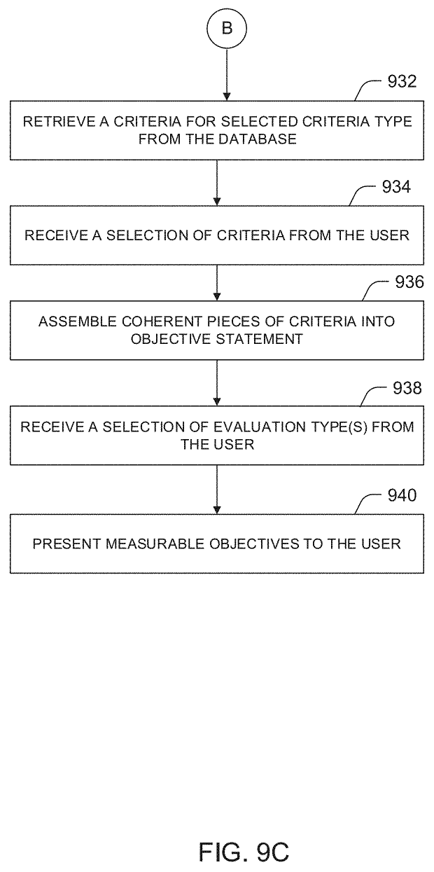

FIGS. 9A-9C illustrates a flowchart of an exemplary method 900 for creating measurable objectives in accordance with an embodiment of the present disclosure. Further, the measurable objectives may include at least three parts: “Observable Action”, At least one Measurable Criterion”, and “Conditions of Performance”. Examples of the condition under which desired results may be performed may include, but are not limited to, in front of at least one observer, within the time limit of 60 seconds, and so forth. Examples of the criteria for determining how well and when the behavior is to be performed may include, but are not limited to, with no error, after completing the training program, and so forth.

The method 900 starts at step 902. At step 902, one or more training goals may be created by the content management system 110 based on the input from a user such as the user 102.

Subsequently at step 904, the content management system 110 may create performance objectives based on the training goals (or learning goals). At step 906, measurable objectives for each of the performance objectives may be created by the content management system 110. In some embodiments, the objectives design module 314 of the design module 310 creates the measurable objectives for each of the performance objectives.

Subsequently at step 908, the content management system 110 (or the design module 210) may receive a selection of an objective domain from the user 102. The domain may be selected from knowledge, skill or an attitude. At step 910, the content management system 110 may create specific knowledge/action for the measurable objectives. Then at step 912, the content management system 110 may retrieve domain applicable comprehension levels from a database of the content management system 110. The database of the content management system 110 may store information such as, but not limited to, the conditions, criteria, comprehension levels, evaluation types, mastery test, evaluation plans, course material, evaluation questions, evaluation answers, scores, pre-defined score thresholds, and so forth. Further, the database may store the information using suitable data structures, such as tree data structure, linked lists, graphs, arrays, and so forth. Thereafter, at step 914, the content management system 110 may set default types for condition and criteria for the measurable objectives.

At step 916, the content management system 110 may receive a selection of comprehension level from the user 102. The user 102 may select the comprehension level from a displayed list of comprehension level and list is displayed at the interface 206. At step 918, the content management system 110 may retrieve verbs for the selected comprehension levels from the database. At step 920, a selection of an appropriate verb is received from the user 102. In some embodiments, the design module 210 may receive the selection of the appropriate verb from the user 102.

Subsequently at step 922, the content management system 110 may recommend evaluation type for the selected verb retrieved from the database via the interface(s) 206. At step 924, the content management system 110 may receive a selection of the condition type from the user 102. The condition type may be an environment, or resource. The user 102 may select the condition type displayed on the interface 206. At step 926, the content management system 110 may retrieve the condition for the selected condition type from the database.

At step 926, the content management system 110 may receive a selection of the condition from the user 102. In some embodiments, the design module 210 receives the selection of the condition from the user 102. Then at step 930, the content management system 110 may receive a selection of criteria type from the user 102. In some embodiments, the design module 210 receives the selection of the criteria type from the user 102. The criteria type may be speed, accuracy, or standard displayed on the interface(s) 206 for selection by the user 102. Thereafter, at step 932, the content management system 110 may retrieve criteria for selected criteria type from the database. At step 934, the content management system 110 may receive a selection of criteria from the user 102. The design module 210 may receive the selection of the criteria. Subsequently at step 936, the content management system 110 may assemble coherent pieces of criteria into an objective statement. At step 938, the content management system 110 may receive a selection of evaluation type(s) from the user 102. The design module 210 may receive the selection of the evaluation from the user 102. Thereafter, at step 940, the measurable objectives may be presented to the user 102. In some embodiments, the measurable objectives are presented on the computing device 104.

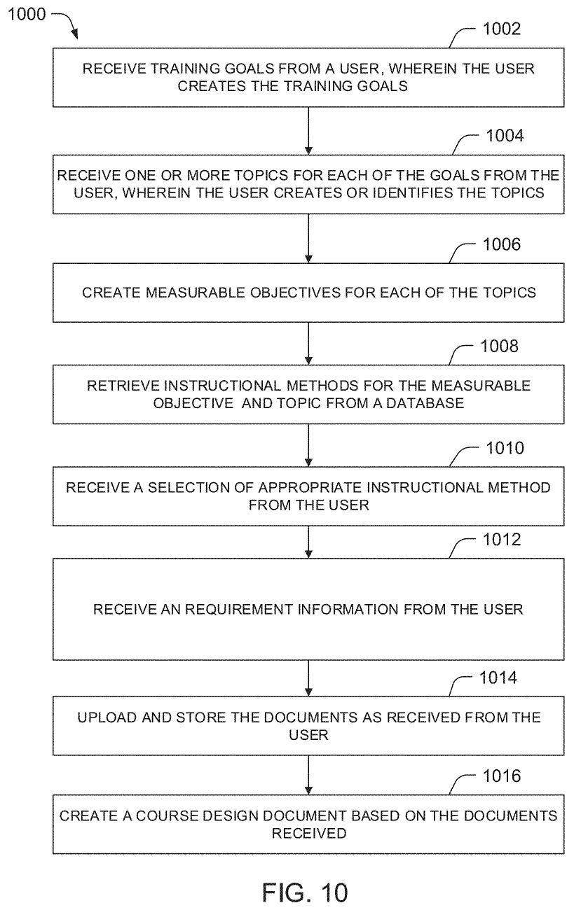

FIG. 10 illustrates a flowchart of an exemplary method 1000 for creating an instruction plan (or a course design document) in accordance with an embodiment of the present disclosure. The content management system 110 may create an instructional plan for each domain within a topic based on inputs from a user such as, the user 102. The content management system 110 may calculate the total time for the instruction plan automatically.

At step 1002, the content management system 110 may receive the training goals from a user such as, the user 102. The design module 210 may receive the training goals. At step 1004, the content management system 110 may receive one or more topics for each of the goals from the user 102. The user 102 may create or identify the topics. At step 1006, the content management system 110 may create the measurable objectives for each of the topics.

At step 1008, the content management system 110 may retrieve instructional methods for the measurable objective and topic from a database of the content management system 110. Then at step 1010, a selection of appropriate instructional method may be received by the content management system 110 from the user 102. At step 1012, the content management system 110 (or the design module 210) may receive requirement information from the user 102. The requirement information may include a time required for the instruction method, class room tools required for execution of the instructional method, and documents required for the instructional method. Then, at step 1014, the documents received from the user 102 may be uploaded in the content management system 110. The documents may be uploaded in the database of the content management system 110. Thereafter, at step 1016, the content management system 110 may create a course design document (or the instruction plan) based on the received documents.

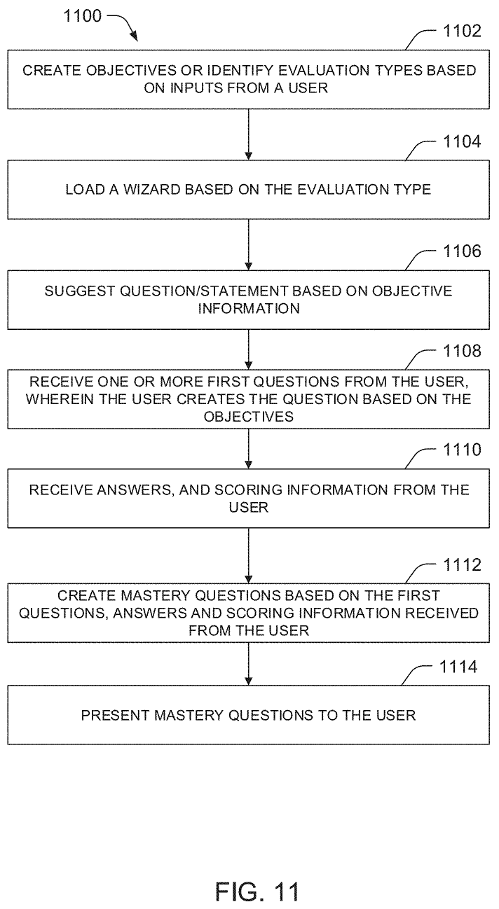

FIG. 11 illustrates a flowchart of an exemplary method 1100 for creating an evaluation test or mastery test in accordance with an embodiment of the present disclosure. As discussed with reference to FIGS. 1A-1D, the content management system 110 can be accessed by the user 102 via interface(s) 206.

At step 1102, the content management system 110 may create objectives or identify evaluation types based on inputs from a user such as the user 102. The objectives may be specific and may reflect one observable performance outcome. Observable performance outcome may include three parts: an observable action, conditions of performance, and at least one criterion of success. Further, the observable performance outcome may be tied to the performance metric. Then at step 1104, the content management system 110 may load a wizard based on the evaluation type. At step 1106, the content management system 110 may suggest questions or statements based on the objective information. Then at step 1108, the content management system 110 may receive one or more first questions from the user 102. The user 102 may create the questions based on the objectives. At step 1110, the content management system 110 may receive answers, and scoring information from the user 102.

Subsequently at step 1112, the content management system 110 may create mastery questions based on the first questions, answers and scoring information received from the user 102. The database of the content management system 110 may store the mastery questions, answers and scoring information. The scoring information may include numerical values, or pass/fail information. The user 102 (or second user 112) may provide passing percentage or score such as post-test passing percentage, pre-test passing percentage, transfer test passing percentage, and post to transfer acceptable percentage drop. Thereafter, at step 1114, the mastery questions may be presented to the user 102 via the interface(s) 206.

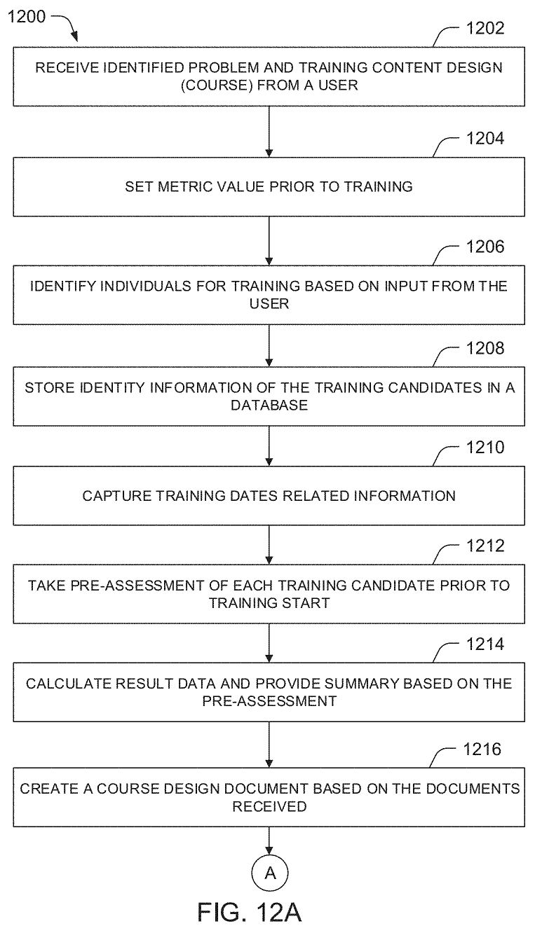

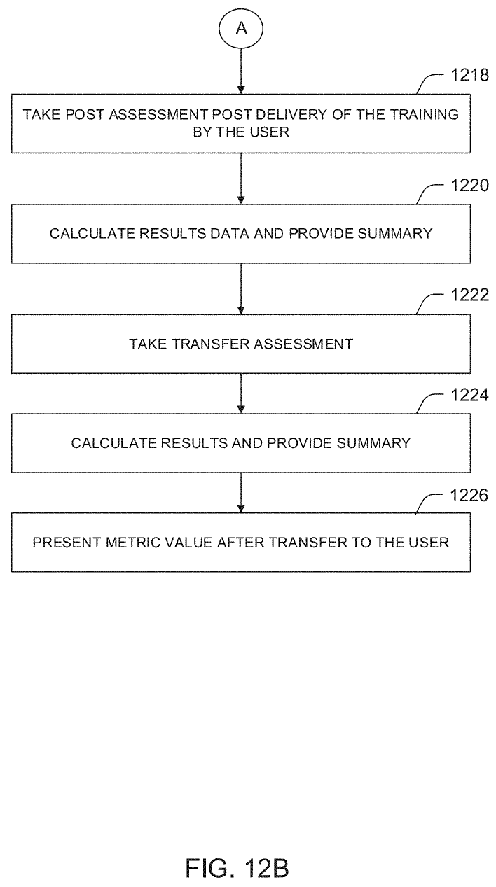

FIGS. 12A and 12B illustrates a flowchart of an exemplary method 1200 for evaluating performance of a training candidate and providing a result summary in accordance with an embodiment of the present disclosure. As discussed with reference to FIGS. 1A-1D, the content management system 110 may be configured to design evaluation plan and evaluate performance of training candidate(s) using one or more disclosed modules.

At step 1202, the content management system 110 may receive an identified problem and training content design (course) from the user 102. At step 1204, the content management system 110 may set metric values prior to training based on inputs from the user 102. Then at step 1206, the content management system 110 may identify individuals for training based on input from the user 102. Further at step 1208, the content management system 110 may store identity information of the individuals or training candidates in a database of the content management system 110. Then at step 1210, the content management system 110 may capture training date's related information.

At step 1212, the user 102 may take a pre-assessment of each of the training candidates prior to training start using the content management system 110. At step 1214, the content management system 110 may calculate result data and provide summary based on the pre-assessment of the training candidates. At step 1216, the content management system 110 may create a course design document based on the documents received. Then at step 1218, the user 102 may take a post assessment after delivery of the training to the training candidates. At step 1220, the content management system 110 may calculate results data and provide a summary to the user 102. Then at step 1222, the content management system 110 may take a transfer assessment of the training candidates. Thereafter, at step 1226, the content management system 110 may present metric value after transfer via the interface(s) 206 to the user 102.

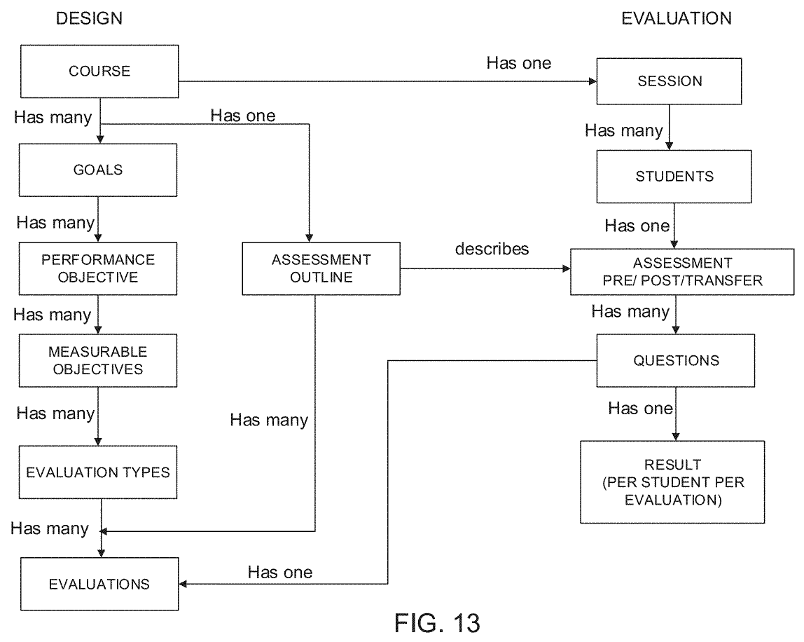

FIG. 13 illustrates a block diagram of an exemplary data structure for design plan and evaluation plan in accordance with an embodiment of the present disclosure. As shown, a course may have many goals, the goals may have many performance objectives, and the measurable objectives may have many evaluation types. The evaluation types may have multiple evaluations. A database of the content management system 110 may store the course, goals, performance objectives, measurable objectives, evaluation types, and evaluations. The course may also include an assessment outline that may further include one or more evaluations.

In an evaluation plan, a session or training session may be given to multiple students (or training candidates). Each of the students may have one assessment of each type. The assessment type may be pre-assessment, post assessment, and transfer assessment. The assessment may happen based on multiple questions. The multiple questions may be evaluated and may have one evaluation and one result per student per evaluation.

FIG. 14 illustrates an exemplary user interface 1400 for creating measurable objectives in accordance with an embodiment of the present disclosure. As discussed with reference to FIG. 1A, the measurable objective creation process may be carried out with the support of an automated system, such as the content management system 110, that may guide the creator through each step of the process. The content management system 110 may be configured to ensure proper measurable objective construction (i.e. requirement of both condition and criteria), to house and access the comprehension level and learning verb database, to present valid selection options for each step of the creation process, to recommend particular options (such as assessment type based on learning verb), to save objectives for later use, and so on. The user 102, such as the administrators, trainers, managers, reviewers, and so forth may access the content management system 110 for measurable objectives' creation. The user 102 may enter his/her login credentials for accessing the content management system 110 on a computing device such as, the computing device 104.

As shown, the user interface 1400 includes multiple tabs including a measurable objectives tab 1402 for creating the measurable objectives. The user interface 1400 may also include multiple input boxes 1406A-1406N where the user 102 can enter or select the values from the drop down menus. The drop down menus may be adaptive drop down menus that may allow the user 102 either to select from the pre-defined data values or enter new data values in the list. The domain 1404 of the objectives can me knowledge, skill, and attitude.

While building a specific knowledge for a knowledge objective the user 102 may require answering question(s) such as, “what do we want the student to know?” For example, for determining the specific knowledge needed for a knowledge objective, the user 102 may complete the following sentence: “The students need to know _”. The user 102 may complete the sentence by entering one of the following exemplary responses: “the definition of moiety”, “how to write a sentence”, “when to take out the trash”, “where to find the office supplies”, and so forth.

The user interface 1400 may also include one or more output box 1408A-1408C for displaying output to the user 102. For example, the generated objectives may be displayed in the output box 1408A.

When the user 102 selects the domain 1404 from the knowledge, skill, or attitude then the content management system 110 may retrieve appropriate comprehension level choices from the database. The content management system 110 may set default types for condition and criteria. The content management system 110 may determine and record behavior for the objective. The system may phrase in response to the appropriate question. The question may include, but are not limited to, for knowledge—What will the student need to know? for skill—What will the student be doing?, for attitude—What behavior will the student be displaying?

The user 102 may select a degree or level to which learning should occur (comprehension level) from a pre-stored set of domain-specific choices as displayed in the drop down menu. Further, the content management system 110 may retrieve appropriate learning verb choices for the indicated comprehension level. The learning verb may describe the desired behavior that is selected from the verbs available for the selected comprehension level from the drop won menu.

The content management system 110 may recommend a particular assessment type based on learning verb selection. A condition type may be selected by the user 102 based on requirements, such as, but not limited to, environment or resource. Further, the content management system 110 may retrieve condition choices for the selected type from database.

Specific condition under which the student must demonstrate the learning objective may be selected or created by the user 102. A criteria type may also be selected based on requirements: speed, accuracy, or standard by the user 102. The content management system 110 may retrieve criteria choices for the selected type from the database. Specific criteria to which the student must demonstrate the learning objective may be selected or created by the user 102.

The system may assemble the measurable objective components into a coherent statement. The user 102 may select a desired type(s) of assessment for a measurable objective from a displayed list of choices, where typically a specific assessment type is recommended based on the applicable learning verb.

During or after creation of the measurable objectives, the content management system 110 may organize the measurable objectives by topic and objective domain (knowledge, skill, or attitude). The measurable training process may continue with the creation of Instructional Plans for each topic/domain combination present.

The content management system 110 may be configured to retrieve the applicable measurable objectives, ensure proper instructional plan construction (requiring particular items, etc.), to present valid selection options for the process steps as appropriate, to track and calculate total instruction time, to store and retrieve any associated documents associated with the plan, to automatically generate a design document that presents the instructional plan information for use in learner instruction, and so on.

After the training instruction is designed the process continues with the creation of a mastery test, which quantitatively assesses learning of the measurable objectives. For each measurable objective/assessment type combination one or more assessments (mastery questions) may be created by the content management system 110.

The content management system 110 may be configured to ensure proper assessment construction, provide a wizard to simplify creation, to suggest the assessment question or statement based on the measurable objective, to store created assessments for later use, to automatically generate a complete mastery test for use in collecting learning data, and so on.

The content management system 110 may further create a question/statement for the selected assessment type based on the requirements of the objective. The content management system 110 may collect answer information to the question/statement from the user 102. The content management system 110 may also collect scoring information for each question/statement from the user. The content management system 110 may store all such information in the database. The content management system may be configured to create the mastery question based on information collected.

The measurable training design process is generally complete at this point. Learning goals directly link to measurable objectives, which link to instructional plans and assessments. The mastery test measures each learner's specific learning performance for against measurable objective.

In an exemplary scenario, a manager at a recruiting company may recognize that the recruiters within the company are not always making good matches between candidates and the open positions to be filled, and believes the problem may be addressed with training. The manager may locate a training designer who will develop the training course to address the problem. The manager and the training designer together may determine the high level goal for the course: To qualify a candidate and align him or her with the correct opportunity. The training designer may perform a Gap Analysis, which includes reviewing the recruiter's job requirements (duties) and tasks to accomplish those duties. The job requirements' analysis may reveal skills and tasks that may impact the performance metric. These tasks and skills may be based on the training objectives. The analysis results in identification of the type of performance and level of performance needed to accomplish the goal: Recruiters are required to identify candidates, determine candidate's qualifications, and select the appropriate jobs for the candidate to fill.

In addition, the training designer may identify an existing standard—the Job/Candidate Match Checklist document that specifies how candidates should be matched to job openings. The manager and training designer may review the original high-level goal against the results of the gap analysis and determine that it aligns with the original intent. This determination may be based on the conclusion that the goal aligns with the job requirements and standards to complete the goal are present.

The training designer may recognize that the tasks required for achieving the course goal require the development of knowledge (how to assess the candidate, questions to ask, things to determine from a candidate and an opportunity) and the development of a skill (determining which items in the candidates resume and the opportunity align). As knowledge and skill can be affected by training, the trainer concludes the goal can be achieved with a training intervention.

At this point the training designer may break down the high level goal into performance objectives the student will need to be able to perform on the job. Multiple performance objectives may be created, but for this example the only one will be considered: Matching a candidate to a job. The training designer may create a measurable knowledge objective by for the performance goal through the following steps: Specific knowledge of training candidates may be determined by answering the questions such as, but not limited to, what will the student need to know?, how to match a candidate to a job?

The verb ‘know’ may be chosen as the student must be able to recall the specific knowledge in order to achieve the performance goal. Condition may be determined using the job standards and is based on the actual job requirement of being provided with a candidate resume: Given a candidate resume. Criteria may be based on the identified job standard and in accordance with the job candidate match checklist. The components of the objective are assembled into a coherent measurable objective: “Given a candidate resume the student knows how to match a candidate to a job in accordance with job candidate match checklist.” Based on the selected verb ‘know’, the training designer may determine this objective will best be evaluated using multiple-choice assessments. Utilizing the measurable objective's condition and criteria, the training designer may determine this measurable objective will best be taught with a “Demonstration and Discussion” method in the classroom. The final step in the measurable training design for this objective is to create the assessments that measure the student's mastery of the concept (knowledge or skill). Again referring to the measurable objective, the training designer may develop the following multiple choice assessment: Which of the below criteria is not one of the 5 criteria you use to match a candidate resume with a job according the Job/Candidate Match Checklist?, Geographically aligned to the position, College matches with requirements, Most recent responsibilities align, Unemployment gaps aren't over a year

The training designer may develop additional assessments by using the content management system 110 as necessary to ensure the measurable objective is fully addressed. The training designer may continue the measurable design process with additional measurable objectives, instructional plans, and assessments until the design is complete.

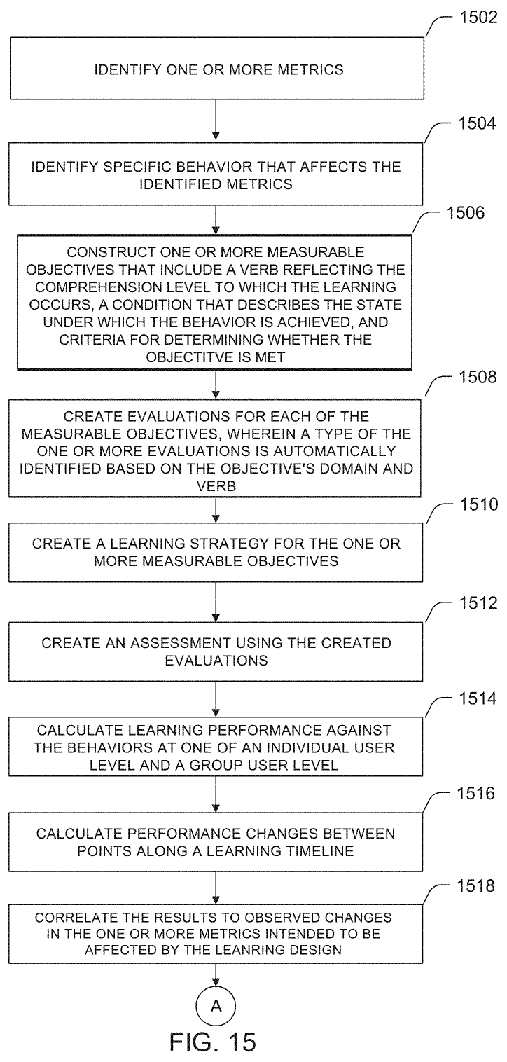

FIG. 15 illustrates a flowchart of an exemplary method for constructing measurable objectives from the learning design in accordance with embodiments of the present disclosure. At step 1502, one or more metrics may be created by the content management system 110 based on the input from a user such as the user 102. The method continues identifying the specific behaviors 1504 that affect the identified metrics. Specific behaviors may correspond to behaviors at both the individual (for example, at student) and group (for example, at class) levels. The specific behaviors may further correspond to changes between points along the learning timeline, and observed changes in the metric (or metrics) intended to be affected by the learning design. The method continues by constructing one or more measurable objectives that include a verb reflecting the comprehension level to which the learning occurs, a condition that describes the state under which the behavior is achieved, and criteria for determining whether the objectives are met 1504 and creating evaluations of the measurable objectives, wherein a type of the one or more evaluations is automatically identified based on the objective's domain and verb 1506. In other embodiments, constructing one or more measurable objectives may also include providing a template for object construction that may indicate that the component types define each object, providing controls to identify specific components, retrieving available components from a database and presenting them to the user for selection, filtering components based on the design state, recommending components for the design, retrieving historical performance data for the objects, performing a real-time quality analysis of the design objects and considering factors such as completeness, incorporation of recommended items, historical performance of similar objects, etc. At step 1508, the method includes creating evaluations for each of the measurable objectives, wherein a type of the one or more evaluations is automatically identified based on the objective's domain and verb. The evaluations may be in the form of one or more mastery tests from the determined instruction plan (or instructional strategy). Further, while creating evaluations, each evaluation may be assigned a test points value. There may be three ways to set the test points value: “set questions equal”, “set answers equal”, and “set test points value manually”. In “set questions equal” method, “1” point may be set for each evaluation, effectively making all evaluations of equal points. In “set answers equal” method, “1” point may be set for each possible answer in each evaluation. Some evaluations may have more than one answer, for example—a checklist, and this may assign “1” point for each answer. In “set test point values manually” method, the user 102 may enter the number of test points manually for an evaluation. The method further includes creating a learning strategy for the one or more measurable objectives at step 1510 and includes creating an assessment using the created evaluations 1512. The learning strategy may correspond to a quantification of their learning achievement. The mastery test may measure each learner's specific learning performance for against measurable objective. Further, the mastery test may include one or more questions.

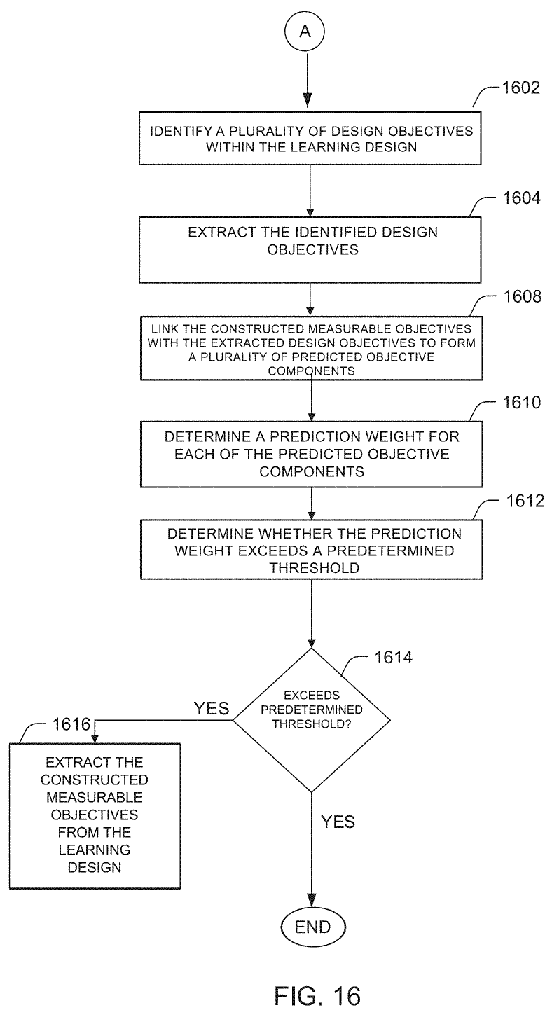

With continuing reference to FIG. 15, the method further includes calculating learning performance against the behaviors at one or an individual user level and a group level 1514. Calculating learning performance may also correspond to calculations against the specific behaviors at both the individual (for example, at student) and group (for example, at class) levels, and calculating performance changes between points along the learning timeline 1516, and to correlate the results to observed changes in the metric (or metrics) intended to be affected by the learning design 1518. The method continues to reference character “A” which denotes a continuation step to FIG. 16. In an alternate embodiment, the learning design may include a data model incorporated which may include the steps of calculating expected performance by four possible approaches: (1) analyzing historical performance for the learning object (objective, instructional plan, evaluation), by considering performance on the same or earlier versions of the learning object; (2) analyzing the components of the learning object, specifically via machine learning models; (3) predicting performance based on historical performance of learning objects with similar components; and (4) calculating the expected value from random selection. Each evaluation type has a mathematically predictable score that would be achieved by random selection (i.e. a multiple-choice question with 4 options and 1 correct answer would expect ¼ or 25% correctness by random selection). These four components may be considered individually or combined into a performance prediction or prediction weight for each learning object. Each may be weighted based on some conditions (amount of historical data, level/confidence of similarity, etc.), and then combined or linked such that items with higher weights make a stronger contribution to the final prediction. The predictions for each learning object may be combined to form an aggregate prediction for the complete learning design. This prediction may be used for various purposes, including as a design quality metric, for example a high predicted score on a Pre-Test may warrant a redesign or as risk mitigation, for example a high predicted score on a Post-Test provides confidence before a large training roll-out.

In other embodiments of the present disclosure, the method may include additional determinations and calculations of defining the learning design components, observed, changes, and/or learning performance. For instance, by defining learning design components as having specific parts, the system enables an automated determination of design quality. The components considered may include: (1) performance metric; (2) outline goals, topics, and objectives; (3) domain, comprehension level, verb, specific knowledge, condition, criteria; (4) evaluation questions statement, answers, points values; and (5) instructional plans: strategy, support materials, and allotted time. Since these components may be utilized at each course design, the design module may use algorithms to automatically calculate the level of completion of any design by considering presence or absence of these items. For example, an objective is considered 100% complete if it has a domain, comprehension level and verb, specific knowledge, condition, and criterial. An objective that is missing one or more items is considered partially complete, so an objective without a condition or criteria may be considered 67% complete ( 4/6). In addition, the design module may use algorithms to inspect the specific the design components and calculate a quality level for the design. It is noted that either the design module or the assessment module may execute the above functions and calculations. When executing the calculations for defining the learning design components, observed, changes, and/or learning performance, the system may also consider: (1) identification of a performance metric; (2) appropriate number of goals and topics; (3) ratio of knowledge and skill objectives; (4) completeness of the objectives (includes condition and criteria); and (5) rigor of the objectives.

The algorithms/module(s) may consider performance against these items and aggregate/link the results into a value that represents the level of design quality. In some cases, this may be a percentage score, with 100% indicating the highest quality achievable and 0% indicating the lowest. For example, a standard may be specified that a learning design should have no more than 2 goals. A design with 1-2 goals can receive a score of 100% for that item. Various designs with more than 2 goals may receive a 0% score for that item. Alternatively, the score could be reduced by some amount for the degree to which the standard is exceeded, for example −25% for every goal over 2, so a design with 4 goals receives 50% for that item. Scores for each of the individual quality items may be combined (averaged, weighted average, etc.) to provide a single aggregate score for the design.

FIG. 16 illustrates a flowchart of an exemplary method for extracting constructed measurable objectives from the learning design in according with embodiments of the present disclosure. As shown at step 1602, which is a continuation from step 1518, the method includes identifying a plurality of design objectives, and continues to step 1604 by extracting the identified design objectives. The method further includes linking the constructed measurable objectives with the extracted design objectives to form a plurality of predicted objective components 1608. Currently, learning design systems receive an excessive amount of data items, e.g. measurable objectives, verbs, domains, and the like, for processing in order to produce a mastery test or learning model. However, by extracting the identified design objectives and linking them with the constructed measurable objected, the overall system processing executing on the learning design is improved by reducing the workload capacity by at least 50% (over half), and thus, increasing system performance over 50% (over half). The method further includes determining a prediction weight for each of the predictive objective components 1610. As mentioned above, the prediction weight may correspond to one of four components that may be considered individually or combined into a prediction weight for each learning object. Each may be weighted based on some conditions (amount of historical data, level/confidence of similarity, etc.), and then combined or linked such that items with higher weights make a stronger contribution to the final prediction. The predictions for each learning object may be combined to form an aggregate prediction for the complete learning design. This prediction may be used for various purposes, including as a design quality metric, for example a high predicted score on a Pre-Test may warrant a redesign or as risk mitigation, for example a high predicted score on a Post-Test provides confidence before a large training roll-out. Continuing at step 1612, a determination is made as to whether the prediction weigh exceeds a predetermined threshold. The predetermined threshold may correspond to any one of the four-component high or lower weight scores which are combined to form an aggregate prediction. The predetermined threshold may further correspond to a greater data value of the design quality metrics set after sorting each of the predicted objective components. The predetermined threshold may also be a lower data value after sorting each of the predicted objective components. At step 1614, when the determination is made as to whether the prediction weight exceeds a predetermined threshold, if yes, the method continues to step 1616 in which the method extracts the constructed measurable objectives from the learning design. By extracting the constructed measurable objectives, the overall system processing on the learning design is improved by reducing the workload capacity by at least 50% (over half), and thus, increasing system performance over 50% (over half). Furthermore, by extracting the constructed measurable objectives, less processing tasks are queued for processor, thus preventing processor bottleneck and excessive CPU and memory utilization. In an alternate embodiment, further improvements to the overall operation of the learning design system in extracting objectives from the design and communicating to the user receiving the learning strategy. The objectives may also be communicated to users prior to utilizing the learning strategy in order to set the user's expectations for the learning program. As such, providing objectives and performance components against the measurable objectives increases the user's engagement with the learning program, since the user may understand exactly how they are being evaluated. This addresses a significant limitation of existing design approaches that don't directly link objectives to measurements, meaning, current learning programs only provide objectives to the students, but cannot show the student's performance against those objectives, which in turn, limits the effective learning value to the students. The learning design components may also be extracted, captured, or acquired at distinct times relative to a learning delivery framework. For instance, the learning delivery framework may include a pre-measurement protocol (e.g. before the learning delivery), post-measurement protocol (e.g. immediately after learning delivery), or a transfer-measurement protocol (e.g. a delay after learning delivery, typically 30 days).

In other embodiments, further improvements to the functioning of the learning design system include incorporating a data model that processes calculations directed to expected performance protocols in three additional design components: (1) analyzing historical performance for the learning data objects (objective, instructional plan, evaluation) by considering performance on the same or earlier versions of the learning object; (2) analyzing the components of the learning object via statistical or machine learning models while predicting performance based on historical performance of learning data objects with similar design components; and (3) calculating an expected value from random selection where each evaluation type has a predictability score that could be achieved by random selection (e.g. a multiple-choice question with 4 options and 1 correct answer would expect¹% or 25% correctness by random selection). These three additional design components may be considered individually or combined into a performance prediction model for each learning object. The algorithm implemented when executing the additional design components may consider which factor is well suited for processing (e.g. historical or similar data). Each factor may be weighted based on various conditions (amount of historical data, level/confidence of similarity, etc.) and then combined and/or linked such that items with higher weights make a stronger contribution to the final rendered prediction. The predictions for each learning object may be combined/linked to form an aggregate prediction for the complete learning design. This prediction may be used for various purposes, including as a design quality metric, for example as a high predicted score on a Pre-Test warranting a redesign or as a risk mitigation, for example, as a high predicted score on a Post-Test providing confidence before a large training roll-out.

In other embodiments, further improvements to the functioning of the learning design system include incorporating a data model that defines learning design components with functional parts that enable automated determinative design quality. The functional parts include goal outlines, goal topics, goal objectives, objective domains, verb, specific knowledge, condition, and criterial, comprehension levels, strategic instructional plans and allotted time sequences. Since these components/functional parts may utilized in each course design in which the software may use algorithms to automatically calculate the level of completion of each design by considering presence or absence of these components/functional parts. For example, an objective is considered 100% complete if it has a domain, comprehension level, a verb, specific knowledge, condition, and criterial. An objective that is missing one or more components/functional parts is considered partially complete, thus, an objective without a condition or criteria may be considered 67% complete ( 4/6). Furthermore, the learning design software may utilize algorithms in order to inspect the components/functional parts and calculate a quality level for the design components which may include identifying a performance metric, appropriate goal and topic count, ratios of knowledge and skill objectives, completeness of the objectives, complexity and rigor of the objectives, and the time sequence allotted in executing the instructional plan comprised of the objectives. The algorithms may consider performance against these items and aggregate the results into a value that represents the level of design quality. In some cases, this may be a percentage score of 100% indicating the highest quality achievable and 0% indicating the lowest quality achievable. A standard may be specified that a learning design should have no more than two goals and a design could have one to two goals receiving a score of 100% for each item. Further, designs with more than two goals may receive a 0% score for each item in which the score could be reduced by some amount for the degree to which the standard is exceeded. For example, −25% for every goal over two, a design with four goals receives 50% for the item. Scores for each of the individual quality items may be combined (averaged, weighted average, etc.) to provide a single aggregate/linked score for the design.

In other embodiments, further improvements to the functioning of the learning design system include incorporating a data model that defines learning design components with functional parts that enable automated calculation of estimated design cost. Design cost is a function of the time required to develop the learning design. Two functional embodiments executed when determining design cost include a stopwatch protocol and industry standard component. The stopwatch protocol may include tracking via starting and stopping an incremental clock when processing is begin performed. This method is not preferred as it is complex and prone to error and inaccuracy. However, requiring the user to start and stop the clock when he/she is designing is also difficult. The user may forget to start/stop or get distracted while “on the clock”, which results in inaccurate time values. The industry standard component involves determining standard design time for each component and adding each of the times to create an estimate. This is the preferred approach. Standards may be defined by industry and/or organization. Additionally, the experience level of the designer may be considered (i.e. less experience requires more time) and applied as a modifier to the estimated value. For example, a designer with less than 100 hours of design experience may expect to take 30% longer than an experienced designer. In this case, a design-time estimate of 20 hours would be adjusted to 20×1.3=26 hours. Other algorithms may be used for the experience modifier.

Reference throughout this specification to “a select embodiment”, “one embodiment”, or “an embodiment” means that a particular feature, structure, or characteristic described in connection with the embodiment is included in at least one embodiment of the disclosed subject matter. Thus, appearances of the phrases “a select embodiment”, “in one embodiment”, or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

The above specification, examples and data provide a complete description of the structure and use of exemplary embodiments of the present disclosure. Although various embodiments of the present disclosure have been described above with a certain degree of particularity, or with reference to one or more individual embodiments, those skilled in the art could make numerous alterations to the disclosed embodiments without departing from the spirit or scope of this present disclosure. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the present disclosure as defined in the following claims.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The terminology used herein is for the purpose of describing particular embodiments only and is not intended to be limiting of the disclosure. It will be appreciated that several of the above-disclosed and other features and functions, or alternatives thereof, may be combined into other systems, methods, or applications. Various presently unforeseen or unanticipated alternatives, modifications, variations, or improvements therein may subsequently be made by those skilled in the art without departing from the scope of the present disclosure as encompassed by the following claims.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs may be implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
using at least one specialized processor and memory to perform the steps of:
creating, by the specialized processor, a measurable learning design for influencing one or more organizational metrics by identifying behaviors that affect the one or more organizational metrics and for developing measurable learning units to teach such behaviors such that performance against the learning units is measurable and can be correlated with performance for one or more metrics at both individual and group behavior levels, wherein the measurable learning units are defined by one of any one of a learning strategy, an evaluation, and an objective in which the performance against the measurable learning unit is calculated by determining the performance against the objective;
constructing, by the specialized processor, measurable objectives to include a verb reflecting the comprehension level to which the learning should occur, a condition that describes the state under which the behavior must be achieved, and criteria for determining if the objective was successfully met,
wherein the measurable objective comprises a plurality of discrete components including verb, condition, and criteria, stored in the memory, wherein said discrete components are reused by other measurable objectives,
creating, by the specialized processor, one or more evaluations for each of the measurable objectives
wherein a type of the one or more evaluations is automatically identified based on the objective's domain and verb;
creating, by the specialized processor, a learning strategy for the one or more measurable objectives, wherein the learning strategy is stored in memory such that the identified behaviors are acquired, wherein the learning strategy is recommended based on the objective's domain, which is readily identified from the objective's verb discrete component;
creating, by the specialized processor, an assessment using the created set of evaluations such that the assessment is delivered to each student attending the learning program and provide a quantification of learning achievement of the student, wherein the learning achievement is aggregated to show specific performance by any one of evaluations, objectives, learning units, and metrics; and
calculating, by the specialized processor, learning performance against the behaviors at one of an individual user level and a group user level;
calculating, by the specialized processor, performance changes between points along a learning timeline;
correlating, by the specialized processor, the results to observed changes in the one or more metrics intended to be affected by the learning design;
identifying, by the specialized processor, a plurality of design objectives within the learning design;
extracting, by the specialized processor, the identified design objectives;
linking, by the specialized processor, the constructed measurable objectives with the extracted design objectives to form a plurality of predicted objective components;
determining, by the specialized processor, a prediction weight for each of the plurality of predicted objective components;
determining, by the specialized processor, whether the prediction weight exceeds a predetermined threshold; and
in response to determining that the prediction weight exceeds a predetermined threshold, extracting the constructed measurable objectives from the learning design, whereby extracting the constructed measurable objectives enhances the functionality and speed of the specialized processor when correlating the results to observed changes in the one or more metrics intended to be affected by learning design.

2. The method of claim 1, comprising using a scheduling module comprising at least one processor and memory configured to identify the specific students to receive training, to schedule a learning timeline, to deliver the learning assessment to each identified student at the appropriate time and capture performance of the student on the learning assessment, and to capture both metric and student performance data at a plurality of points along the learning timeline.

3. A system comprising:
a user interface configured to present a mastery test of a learning program or to receive mastery test results from another system; and
at least one specialized processor and memory comprising:
a design module configured to:
identify one or more metrics to be influenced by the learning program;
identify specific behavior that affects the identified metrics;
construct one or more measurable objectives that include a verb reflecting the comprehension level to which the learning occurs, a condition that describes the state under which the behavior is to be achieved, and criteria for determining whether the objective was successfully met;
create evaluations for each of the measurable objectives, wherein a type of the one or more evaluations is automatically identified based on the objective's domain and verb;
create a mastery test from the set of evaluations;
an assessment module configured to:
determine the level of learning achieved after the completion of the training session and a level retained for a predetermined period of time after training completion, wherein the learning achievement is aggregated to show specific performance by evaluations, objectives, learning units, and metrics;
a measurement module configured to:
determine a performance metric associated with a learning goal before and after the training event;
calculate performance changes between points along a learning timeline;
correlate results to observed changes in the one or more metrics intended to be affected by the learning design;
communicate at least one of the learning achievement levels and the performance metric via the user interface after completion of the training session;
identify a plurality of design objectives within the learning design;
extract the identified design objectives;
link the constructed measurable objectives with the extracted design objectives to form a plurality of predicted objective components;
determine a prediction weight for each of the plurality of predicted objective components;
determine whether the prediction weight exceeds a predetermined threshold; and
in response to determining that the prediction weight exceeds a predetermined threshold, extract the constructed measurable objectives from the learning design, whereby extracting the constructed measurable objectives enhances the functionality and speed of the specialized processor when correlating the results to observed changes in the one or more metrics intended to be affected by learning design.

4. The system of claim 3, wherein the learning goal comprises an identification of a performance gap metric between an actual work performance metric and an expected work performance metric.

5. The system of claim 4, wherein the learning goal identifies a performance goal to achieve during the training session to reduce the performance gap metric.

6. The system of claim 3, wherein the design module is further configured to determine the set of evaluations based on one or more measurable objectives of the learning goal.

7. The system of claim 6, wherein the design module is further configured to receive, via the user interface, an input to generate the one or more measurable objectives.

8. The system of claim 7, wherein the design module is further configured to recommend an evaluation type based on the generated one or more measurable objectives.

9. The system of claim 8, wherein the design module is further configured to determine the set of evaluations based on the recommended evaluation type.

10. The system of claim 7, wherein the input comprises a selection of a domain associated with the one or more measurable objectives.

11. The system of claim 10, wherein the domain comprises at least one of a knowledge, skill, or attitude associated with the learning goal.

12. The system of claim 11, wherein the design module is further configured to determine an instructional strategy based on an instructional method selected from a list of instructional methods.

13. The system of claim 12, wherein the design module is further configured to determine the list of instructional methods from the selected domain associated with the one or more measurable objectives.

14. The system of claim 12, wherein the design module is further configured to create the mastery test from the determined instructional strategy.

15. The system of claim 10, wherein the input comprises a selection of a comprehension level associated with the selected domain.

16. The system of claim 10, wherein the input comprises a selection of a verb associated with the selected domain.

17. The system of claim 7, wherein the input comprises a selection of a condition associated with the learning goal.

18. The system of claim 17, wherein the condition comprises at least one of an environment and resource associated with the learning goal.

19. The system of claim 7, wherein the input comprises a selection of criteria associated with the learning goal.

20. The system of claim 19, wherein the criteria comprises at least one of a speed, accuracy, or standard criteria associated with the learning goal.

21. The system of claim 3, wherein the assessment module is further configured to:
present, via the user interface, the mastery test prior to a training event during the training session;
receive, via the user interface, inputs during the presentation of the mastery test prior to the training event;
compare the inputs received during the presentation of the mastery test to the set of evaluations of the mastery test; and
determine a pre-training metric based on the comparison of the received inputs and the set of evaluations of the mastery test.

22. The system of claim 21, wherein the assessment module is further configured to:
present, via the user interface, the mastery test after a training event during the training session;
receive, via the user interface, inputs during the presentation of the mastery test after the training event;
compare the inputs received during the presentation of the mastery test after the training event to the set of evaluations of the mastery test; and
determine a post-training metric based on the comparison of the received inputs and the set of evaluations of the mastery test.

23. The system of claim 22, wherein the assessment module is further configured to:
present, via the user interface, the mastery test a period of time after a training event during the training session;
receive, via the user interface, inputs during the presentation of the mastery test a period of time after the training event;
compare the inputs received during the presentation of the mastery test a period of time after the training event to the set of evaluations of the mastery test; and
determine a transfer-training metric based on the comparison of the received inputs and the set of evaluations of the mastery test.

24. The system of claim 23, wherein the assessment module is further configured to determine the performance metric based on the pre-training metric, the post-training metric, and the transfer-training metric.

25. The system of claim 24, wherein the training metrics quantify the effectiveness of the learning program during the training session.

26. A method for evaluating one or more training candidates in a training session, the method comprising:
at least one specialized processor and memory:
controlling, by the specialized processor, a user interface to present a mastery test of a learning program or receiving mastery test results from a separate system;
identifying, by the specialized processor, a metric to be influenced by the learning program;
identifying, by the specialized processor, specific behavior that affect the identified metric;
constructing, by the specialized processor, one or more measurable objectives that describe the specific behavior, wherein the measurable objectives comprises a plurality of discrete components including a verb reflecting the comprehension level to which the learning occurs, a condition that describes the state under which the behavior is to be achieved, and criteria for determining whether the objective was successfully met,
wherein the measurable objective comprises a plurality of discrete components including verb, condition, and criteria, stored in the memory, wherein said discrete components are reused by other measurable objectives,
wherein constructing the measurable objectives improve and enhance the functionality and capacity of a network in which the processor and memory are connected;
creating, by the specialized processor, evaluations for each of the measurable objectives; and
creating, by the specialized processor, a mastery test from the set of evaluations;
determining, by the specialized processor, the level of learning achieved after the completion of the training session and a level retained for a predetermined period of time after training completion, wherein the learning achievement is aggregated to show specific performance by evaluations, objectives, learning units, and metrics;
determining, by the specialized processor, a performance metric associated with a learning goal before and after the training event;
calculating, by the specialized processor, performance changes between points along a learning timeline;
correlating, by the specialized processor, results to observed changes in the one or more metrics intended to be affected by the learning design,
identifying, by the specialized processor, a plurality of design objectives within the learning design;
extracting, by the specialized processor, the identified design objectives;
linking, by the specialized processor, the constructed measurable objectives with the extracted design objectives to form a plurality of predicted objective components;
determining, by the specialized processor, a prediction weight for each of the plurality of predicted objective components;
determining, by the specialized processor, whether the prediction weight exceeds a predetermined threshold;
in response to determining that the prediction weight exceeds a predetermined threshold, extracting the constructed measurable objectives from the learning design, whereby extracting the constructed measurable objectives enhances the functionality and speed of the specialized processor when correlating the results to observed changes in the one or more metrics intended to be affected by learning design; and
communicating, by the specialized processor, at least one of the learning achievement level and the performance metric via the user interface after completion of the training session.

27. A method for evaluating one or more training candidates in a training session, the method comprising:
at least one specialized processor and memory:
controlling, by the specialized processor, a user interface to present a mastery test of a learning program during the training session or receiving mastery results from a separate system;
creating, by the specialized processor, the mastery test from a set of evaluations for a learning goal of the learning program, wherein the set of evaluations are associated with a measurable objective stored as a reference in the memory, such that the one or more evaluations associated with the measurable objectives stored are identified and retrieved using said the reference, enabling the processor to take full advantage of optimization schemes designed for the retrieval;
determining, by the specialized processor, a performance metric associated with the learning goal after completion of the mastery test during the training session;
determining, by the specialized processor, a learning assessment metric based on the performance metric after the completion of the training session;
identifying, by the specialized processor, a plurality of design objectives within the learning design;
extracting, by the specialized processor, the identified design objectives;
linking, by the specialized processor, the constructed measurable objectives with the extracted design objectives to form a plurality of predicted objective components;
determining, by the specialized processor, a prediction weight for each of the plurality of predicted objective components;
determining, by the specialized processor, whether the prediction weight exceeds a predetermined threshold; and
in response to determining that the prediction weight exceeds a predetermined threshold, extracting the constructed measurable objectives from the learning design, whereby extracting the constructed measurable objectives enhances the functionality and speed of the specialized processor when correlating the results to observed changes in the one or more metrics intended to be affected by learning design,
using, by the specialized processor, the user interface to communicate the learning assessment metric to a computing device after the completion of the training session, whereby the steps recited by the method improve efficiency of the processor and enable the processor to take full advantage of optimization schemes designed for retrieval.

28. A system comprising:
a user interface configured to present a mastery test of a learning program or to receive mastery test results from a separate system; and
at least one processor and memory comprising:
design module configured to:
create a measurable learning design, at the processor, for influencing one or more organizational metrics by identifying behaviors that affect the one or more organizational metrics and for developing measurable learning units to teach such behaviors such that performance against the learning units is measurable and can be correlated with performance for one or more metrics at both individual and group behavior levels,
wherein the measurable learning units are defined by one of any one of a learning strategy, an evaluation, and an objective in which the performance against the measurable learning unit is calculated by determining the performance against the objective;
construct measurable objectives, at the processor, for the identified behaviors of one or more predetermined learning domains, wherein the measurable objectives include a verb reflecting the comprehension level to which the learning should occur, a condition that describes the state under which the behavior must be achieved, and criteria for determining if the objective was successfully met,
wherein the measurable objective comprises a plurality of discrete components including verb, condition, and criteria, stored in the memory, wherein said discrete components are reused by other measurable objectives,
wherein constructing the measurable objectives improve and enhance the functionality and capacity of a network in which the processor and memory are connected;
create one or more evaluations for each of the measurable objectives, wherein a type of the one or more evaluations is automatically identified based on the objective's domain and verb;
create, at the processor, a learning strategy for one or more measurable objectives, wherein the learning strategy is recommended based on an objective's domain, which is readily identified from the objective's verb discrete component;
create a learning strategy for one or more measurable objectives such that the identified behaviors are acquired;
construct an assessment using the created set of evaluations such that the assessment may be delivered to each student attending the learning program;
an assessment module configured to:
provide a quantification of learning achievement, wherein the learning achievement is aggregated to show specific performance by evaluations, objectives, learning units, and metrics; and
calculate learning performance against the behaviors at one of an individual user level and a group user level, to calculate performance changes between points along the learning timeline, and to correlate the results to observed changes in the one or more metrics intended to be affected by the learning design;
identify a plurality of design objectives within the learning design;
extract the identified design objectives;
link the constructed measurable objectives with the extracted design objectives to form a plurality of predicted objective components;
determine a prediction weight for each of the plurality of predicted objective components;
determine whether the prediction weight exceeds a predetermined threshold; and
in response to determining that the prediction weight exceeds a predetermined threshold, extract the constructed measurable objectives from the learning design, whereby extracting the constructed measurable objectives enhances the functionality and speed of the specialized processor when correlating the results to observed changes in the one or more metrics intended to be affected by learning design.
